(19) United States
(12) Patent Application Publication
(10) Pub. No.: US 2016/0344025 A1
(43) Pub. Date: Nov. 24, 2016

(54) TITANATE COMPOUND, ALKALI METAL TITANATE COMPOUND AND METHOD FOR PRODUCING SAME, AND POWER STORAGE DEVICE USING TITANATE COMPOUND AND ALKALI METAL TITANATE COMPOUND AS ACTIVE MATERIAL

(71) Applicants: NATIONAL INSTITUTE OF ADVANCED INDUSTRIAL SCIENCE AND TECHNOLOGY, Tokyo (JP); ISHIHARA SANGYO KAISHA, LTD., Osaka (JP)

(72) Inventors: Hideaki NAGAI, Tsukuba (JP); Kunimitsu KATAOKA, Tsukuba (JP); Junji AKIMOTO, Tsukuba (JP); Yoshimasa KUMASHIRO, Yokkaichi (JP); Tomoyuki SOTOKAWA, Yokkaichi (JP)

(21) Appl. No.: 15/112,632

(22) PCT Filed: Jan. 23, 2015
(86) PCT No.: PCT/JP2015/051816

§ 371 Date: Jul. 19, 2016

(30) Foreign Application Priority Data
Jan. 24, 2014 (JP) 2014-011325

(51) Int. Cl. H01M 4/485; C01G 23/00; H01M 4/131; C01G 23/04

(52) U.S. Cl. CPC H01M 4/485; C01G 23/04; C01G 23/005; H01M 4/131; C01P 2006/40; C01P 2006/12; C01P 2004/62; C01P 2004/03; C01P 2004/54; C01P 2002/72; C01P 2006/80

(57) ABSTRACT

Provided is a titanate compound capable of further increasing the capacity of a power storage device when used as an electrode active material thereof. The titanate compound according to the present invention includes at least 60%, based on the number thereof, of particles having an anisotropic shape and a specific surface area of 10-30 m²/g as measured by a nitrogen adsorption BET one-point method, and having a long-axis diameter (L) in the range of 0.1<L≦0.9 μm as measured by electron microscopy. The method for producing the titanate compound according to the present invention is provided with a step for pulverizing an alkali metal titanate compound until the specific surface area thereof is at least 10 m²/g, a step for annealing the resultant pulverized product, and a step for then bringing the alkali metal titanate compound into contact with an acidic aqueous solution and substituting at least a portion of alkali metal cations in the alkali metal titanate compound with protons, and the method is preferably further provided with a step for heating the proton-substituted titanate compound.

### TECHNICAL FIELD

The present invention relates to a titanic acid compound, an alkaline metal titanate compound, and methods for producing these. The present invention further relates to an electrode and an electricity storage device containing the titanic acid compound and/or the alkaline metal titanate compound.

### BACKGROUND ART

The use of lithium-ion batteries are continuously expanding with portable devices as major applications, and there have recently been studied also the applications of the lithium-ion batteries to new fields of large-size power storage systems, mobile objects and the like. For such applications, lithium-ion batteries using negative electrode active materials having high Li occlusion and release potentials attract attention because of their high safety attributable to their high potentials. On the other side, the lithium-ion batteries have a problem of becoming low in the energy density. Therefore, the development of a titanic acid compound maintaining a high potential and simultaneously having a large capacity is carried out (for example, Non Patent Literature 1, and Patent Literatures 1 and 2).

Non Patent Literature 1 discloses multiple types of titanic acid compounds; and it is understood that among these, H₂Ti₁₂O₂₅ is low in the first-cycle charge and discharge efficiency and the capacity reduction involved in the charge and discharge cycle progress, and is promising as an electrode active material. However, the lithium deintercalation capacity is about 200 mAh/g, and further capacity enhancement is demanded.

The present inventors disclose a titanic acid compound as an electrode active material and a production method thereof in Patent Literatures 1 and 2. However, the lithium deintercalation capacity is about 210 mAh/g at the highest in the second cycle, and further capacity enhancement is demanded.

### CITATION LIST

### Non Patent Literature

Non Patent Literature 1: Akimoto et al., Journal of The Electrochemical Society, 158(5), A546-A549 (2011)

### Patent Literature

Patent Literature 1: JP 2008-255000 A
Patent Literature 2: JP 2010-254482 A

### SUMMARY OF INVENTION

### Technical Problem

The present invention has an object to provide a titanic acid compound which can solve the current problem as described above, and which, when being used as an electrode active material of an electricity storage device, can provide the electricity storage device whose capacity can be more enhanced and which is excellent in the charge and discharge cycle property, the rate property and the like.

### Solution to Problem

The present inventors, in studying improving the discharge capacity (Li deintercalation capacity) of an electrode active material containing a titanic acid compound, considered that making the particle diameter of the active material small is effective. However, it has been made clear that when the average particle diameter of the active material is made small, although the initial Li intercalation capacity becomes high, the improvement in the Li deintercalation capacity is less than that; that is, the charge and discharge efficiency decreases and the Li deintercalation capacity involved in the charge and discharge cycle remarkably decreases, revealing that the active material is insufficient as the electrode active material. Then as a result of exhaustive studies on the solving methods, it has been found that by making a titanic acid compound to have a specific surface area (SSA) in a specific range not by simply making the average particle diameter small but by reducing the number of ultrafine particles and simultaneously making the average particle diameter small, and by making the titanic acid compound to contain an amount equal to or larger than a specific amount of particles having a major-axis diameter in a specific range, there can be obtained the titanic acid compound which, when being used as the electrode active material, can make the Li deintercalation capacity high and the charge and discharge efficiency high, and can reduce the decreasing rate of the Li deintercalation capacity involved in the charge and discharge cycle; and such a titanic acid compound is excellent also in the rate property. This finding has led to the completion of the present invention.

That is, the present invention is:

(1) A titanic acid compound, having a specific surface area of 10 to 30 m²/g as measured by BET one-point method using nitrogen adsorption, and having an anisotropic shape, wherein the titanic acid compound comprises 60% or more of particles having a major-axis diameter L in the range of 0.1<L≦0.9 μm based on the number of particles as measured by electron microscopy.
(2) The titanic acid compound according to (1), wherein the titanic acid compound comprises 60% or more of particles having an aspect ratio L/S in the range of 1.0<L/S≦4.5 based on the number of particles as calculated from the major-axis diameter L and the minor-axis diameter S of the each particle by electron microscopy.
(3) The titanic acid compound according to (1) or (2), having peaks at least at positions of 20=14.0°, 24.8°, 28.7°, 43.5°, 44.5° and 48.6° (with an error of ±0.5° for each case) in an powder X-ray diffraction pattern using a CuKα radiation as a radiation source, wherein with an intensity of the peak at 2θ=14.0° (with an error of ±0.5°) being taken to be 100, no peak having an intensity of 20 or higher is observed between 10.0°≦2θ≦20.0° except for the peak at 2θ=14.0°.
(4) The titanic acid compound according to any one of (1) to (3), having a ratio h₂/h₁ of 0.05 or lower,
wherein
h₁ is a maximum value of dQ/dV at a voltage V in between 1.5 V and 1.7 V, and
h₂ is a maximum value of dQ/dV at a voltage V in between 1.8 V and 2.0 V, in a voltage V-dQ/dV curve,
wherein the voltage V-dQ/dV curve is determined by differentiating capacity Q of the voltage
V-capacity Q curve, with respect to V, obtained at the Li deintercalation side of a coin-type battery,
wherein the battery uses the titanic acid compound as a working electrode and a metallic Li as a counter electrode.
(5) The titanic acid compound according to any one of (1) to (4), wherein the titanic acid compound has a content of sulfur element of 0.1 to 0.5% by mass in terms of SO₃.
(6) The titanic acid compound according to any one of (1) to (5), wherein the particle comprises a compound represented by the general formula H₂Ti₁₂O₂₅ as a main component.
(7) An alkaline metal titanate compound, having a specific surface area of 5 to 15 m²/g as measured by BET one-point method using nitrogen adsorption, and having an anisotropic shape, wherein the alkaline metal titanate compound comprises 60% or more of particles having a major-axis diameter L in the range of 0.1<L≦0.9 μm based on the number of particles as measured by electron microscopy.
(8) The alkaline metal titanate compound according to (7), wherein the alkaline metal titanate compound comprises 60% or more of particles having an aspect ratio L/S in the range of 1.0<L/S≦4.5 based on the number of particles as calculated from the major-axis diameter L and a minor-axis diameter S of the each particle by electron microscopy.
(9) The alkaline metal titanate compound according to (7) or (8), wherein the particle comprises a compound represented by the general formula Na₂Ti₃O₇ as a main component.
(10) A method for producing an alkaline metal titanate compound according to any one of the above (7) to (9), comprising a step of milling an alkaline metal titanate compound until the specific surface area thereof becomes 10 m²/g or larger, and a step of annealing the obtained milled material.
(11) The method for producing an alkaline metal titanate compound according to (10), wherein the milling is carried out in wet milling
(12) The method for producing an alkaline metal titanate compound according to (11), further comprising, after the wet milling step, a step of drying the alkaline metal titanate compound and a dispersion medium without filtration separation.
(13) The method for producing an alkaline metal titanate compound according to (12), wherein the drying is carried out by a spray dryer.
(14) The method for producing an alkaline metal titanate compound according to any one of (10) to (13), wherein the annealing is carried out until the specific surface area of the alkaline metal titanate compound after the annealing is reduced to 20 to 80% of the specific surface area thereof before the annealing.
(15) The method for producing an alkaline metal titanate compound according to any one of (10) to (14), comprising a step of firing a mixture containing, at least, a titanium oxide having a content of sulfur element of 0.1 to 1.0% by mass in terms of SO₃, and an alkaline metal compound to thereby produce the alkaline metal titanate compound having a specific surface area of 10 m²/g or smaller.
(16) The method for producing an alkaline metal titanate compound according to (15), wherein the titanium oxide has a specific surface area of 80 to 350 m²/g as measured by BET one-point method using nitrogen adsorption.
(17) A method for producing a titanic acid compound, comprising a step of bringing the alkaline metal titanate compound obtained by a production method according to any one of (10) to (16) into contact with an acidic aqueous solution to thereby substituting at least a part of alkaline metal cations in the alkaline metal titanate compound with protons.
(18) A method for producing a titanic acid compound, further comprising a step of heating a proton-substituted titanic acid compound obtained by a production method according to (17).
(19) The method for producing a titanic acid compound according to (18), wherein a heating temperature in the heating step is 150 to 350° C.
(20) The method for producing a titanic acid compound according to any one of (10) to (19), wherein the alkaline metal is sodium.
(21) An electrode active material, comprising the titanic acid compound and/or the alkaline metal titanate compound according to any one of (1) to (9).
(22) An electricity storage device, comprising the electrode active material according to (21).

### Advantageous Effects of Invention

When the titanic acid compound according to the present invention is used as an electrode active material of an electricity storage device, an electricity storage device having a higher capacity, a higher charge and discharge efficiency, a reduced decreasing rate of Li deintercalation capacity involved in the charge and discharge cycle, and a better rate property than conventional ones can be obtained.

### BRIEF DESCRIPTION OF DRAWINGS

FIG. 1 is a schematic view illustrating one example of the electricity storage device according to the present invention.

FIG. 2 is a scanning electron microscope photograph of Example 1.

FIG. 3 is an powder X-ray diffraction pattern of Example 1.

FIG. 4 is a scanning electron microscope photograph of Comparative Example 1.

FIG. 5 is a scanning electron microscope photograph of Comparative Example 2.

FIG. 6 is an powder X-ray diffraction pattern of Comparative Example 2.

FIG. 7 is a scanning electron microscope photograph of Comparative Example 4.

FIG. 8 is cumulative relative frequency distributions of major-axis diameters of Examples 1 to 3 and Comparative Examples 1 and 4.

FIG. 9 is cumulative relative frequency distributions of aspect ratios of Examples 1 to 3 and Comparative Examples 1 and 4.

FIG. 10 is charge and discharge curves of Example 1 and Comparative Example 2.

FIG. 11 is dQ/dV vs. V curves of Example 1 and Comparative Example 2.

### DESCRIPTION OF EMBODIMENTS

The technical constitution of the present invention and its action and effect are as follows.

The present invention is a titanic acid compound in which particles thereof, having a specific surface area of 10 to 30 m²/g as measured by BET one-point method using nitrogen adsorption, and having an anisotropic shape, wherein the titanic acid compound comprises 60% or more of particles having a major-axis diameter L in the range of 0.1<L≦0.9 μm based on the number of particles as measured by electron microscopy.

The titanic acid compound according to the present invention is a compound whose crystal lattice is constituted of Ti, H and O, and which is definitely different from titanium dioxide having crystal water and adsorption water.

The titanic acid compound according to the present invention preferably has the following composition formula.

HₓTi_{y}O_{z} (1)

wherein x/y is 0.06 to 4.05; and z/y is 1.95 to 4.05.

Compounds satisfying the formula (1) specifically include titanic acid compounds represented by general formula of HTiO₂, HTi₂O₄, H₂TiO₃, H₂Ti₃O₇, H₂Ti₄O₉, H₂Ti₅O₁₁, H₂Ti₆O₁₃, H₂Ti₈O₁₇, H₂Ti₁₂O₂₅, H₂Ti₁₈O₃₇, H₄TiO₄ and H₄Ti₅O₁₂. The existence of these compounds is confirmed by a peak position of the powder X-ray diffraction measurement.

Among these, preferable are titanic acid compounds exhibiting distinctive peaks of at least positions at 14.0°, 24.8°, 28.7°, 43.5°, 44.5° and 48.6° (with an error of ±0.5° for each case) in powder X-ray diffraction measurement (using a CuKα radiation); and more preferable are, with an intensity of the peak at 2θ=14.0° (with an error of ±0.5°) being taken to be 100, titanic acid compounds having no peak having an intensity of 20 or higher observed between 10.0°≦2θ≦20.0° except for the peak at 2θ=14.0°. The titanic acid compounds exhibiting such an X-ray diffraction pattern include a titanic acid compound represented by the general formula H₂Ti₁₂O₂₅.

In the present invention, the titanic acid compound may be not only one having a stoichiometric composition but even one having a nonstoichiometric composition in which some elements are defective or excessive, as long as being typified by the above-mentioned general formula. Further, other elements may be substituted for a part of hydrogen, titanium and oxygen, or may exist in interstitial sites. Examples of such elements include alkaline metal elements such as lithium, sodium, potassium and cesium; and the content thereof is preferably 0.4% by mass or lower in terms of alkaline metal oxide in the titanic acid compound. The content can be calculated, for example, by X-ray fluorescence analysis.

Further, titanic acid compounds having powder X-ray diffraction peaks originated from other crystal structures, that is, titanic acid compounds having sub-phases in addition to the above-mentioned titanic acid compound as a main phase are included in the scope of the present invention. In the case of having sub-phases, with the intensity of a main peak of the main phase being taken to be 100, the intensities of main peaks attributed to the sub-phases are preferably 30 or lower, and more preferably 10 or lower, and still more preferably, no main peaks of sub-phases are observed, that is, the titanic acid compound is a single phase. Examples of the sub-phases include anatase-, rutile- and bronze-type titanium oxides. Further there may be present a plurality of types of titanic acid compound phases.

The titanic acid compound according to the present invention has a specific surface area of 10 to 30 m²/g as measured by BET one-point method using nitrogen adsorption. The measurement can be carried out by the common BET one-point method using nitrogen adsorption in which nitrogen gas is caused to be adsorbed on a sample while a sample tube is cooled with liquid nitrogen.

Further the titanic acid compound according to the present invention has an anisotropic particle shape. The anisotropic shape refers to a shape such as a plate-, needle-, rod-, column-, spindle- or fiber-shape. In the case where a secondary particle is formed by aggregation of a plurality of primary particles, the shape refers to a shape of the primary particle. The shape of the primary particle can be checked by an electron microscope photograph. It is not necessary that all of particles of the titanic acid compound have anisotropic shapes, but a part of the particles may contain particles having isotropic shapes or indeterminate shapes.

Further the titanic acid compound according to the present invention comprises 60% or more of particles having a major-axis diameter L of 0.1<L≦0.9 μm based on the number of particles as measured by electron microscopy.

The distribution of the major-axis diameter L by electron microscopy is determined as follows. First, a 10,000× photograph is taken by a scanning electron microscope, and the photograph is enlarged so that 1 cm on the magnification scale corresponds to 0.5 μm. A shape (that is, a projection image) of a particle on the photograph is approximated to a rectangle or square in which the particle is inscribed; at least 100 primary particles having a short side thereof of 1 mm or longer are randomly chosen, and the long sides and the short sides of the chosen particles are measured. Then, the major-axis diameter L and the minor-axis diameter S of the each particle are determined by dividing the acquired measurement values of the long side and the short side by the enlarging magnification. The number of particles falling under each class interval of L of 0.1 μm (the upper limit value of the each class is included in the class) on the major-axis diameter L thus determined is counted and divided by the total number of the particles to thereby determine a cumulative relative frequency distribution in terms of the number of particles with respect to L. Based on the thus acquired cumulative relative frequency distribution in terms of the number of particles with respect to L, by subtracting a cumulative ratio (%) at L=0.1 μm from a cumulative ratio (%) at L=0.9 μm, the occupancy (%) in terms of particles of particles of 0.1<L≦0.9 μm can be calculated.

In order to attain the advantage of the present invention, it is necessary that the titanic acid compound is made to have a specific surface area in a specific range, and to contain an amount equal to or larger than a specific amount of particles having a major-axis diameter in a specific range. When the specific surface area exceeds 30 m²/g, presumably because ultrafine particles having a particle diameter of 0.1 μm or smaller become too many, although the first-cycle Li intercalation capacity becomes remarkably high, the improvement in the Li deintercalation capacity is less than that (the charge and discharge efficiency decreases), and further, the Li deintercalation capacity involved in the progress of the charge and discharge cycle remarkably decreases. On the other hand, when the specific surface area is smaller than 10 m²/g, the improvements in the Li deintercalation capacity and the rate property are not attained. Further even if the specific surface area is in the range of 10 to 30 m²/g, when particles having a major-axis diameter L of 0.1<L≦0.9 μm account for less than 60% of particles based on the number of particles, since such a state is made that ultrafine particles and coarse particles are each contained in a much amount, the charge and discharge efficiency decreases and the improvement in the rate property is not attained, and the Li deintercalation capacity in the charge and discharge cycle remains low. Containing 60% or more of particles having a major-axis diameter in the range of 0.1<L≦0.9 μm based on the number of particles represents a state that the major-axis diameters are comparatively equal, and can highly balance the Li deintercalation capacity, the cycle property and the rate property.

The specific surface area is preferably made to be in the range of 10 to 25 m²/g, and more preferably made to be in the range of 12 to 25 m²/g. The particles having a major-axis diameter L in the range of 0.1<L≦0.9 μm account for preferably 65% or more in terms of the number of particles, and more preferably 70% or more. The particles having a major-axis diameter L of 0.1<L≦0.6 μm account for preferably 35% or more in terms of the number of particles, and more preferably 50% or more.

The titanic acid compound according to the present invention preferably comprises 60% or more of particles having an aspect ratio L/S in the range of 1.0<L/S≦4.5 based on the number of particles as calculated from the major-axis diameter L and the minor-axis diameter S of the each particle by electron microscopy. When the titanic acid compound particle has anisotropy, it is observed, though the cause is not clear, that the Li deintercalation capacity is likely to become high. On the other hand, when the aspect ratio becomes too high, a decrease in the rate property is observed and when an electrode is fabricated, the packing density becomes difficult to make high. By making particles having an aspect ratio L/S in the range of 1.0<L/S≦4.5 to be contained in 60% or more of particles based on the number of particles, a high Li deintercalation capacity and a high electrode packing density can be satisfied simultaneously and it becomes easy for the best specific surface area and major-axis diameter to be attained.

The distribution of the aspect ratio L/S by electron microscopy is determined as follows. The L/S of the each particle is calculated from the major-axis diameter L and the minor-axis diameter S of the each particle determined by the above-mentioned method. The number of particles falling under each class interval of 0.5 (the upper limit value of the each class is included in the class) on the L/S thus determined is counted and divided by the total number of the particles to thereby determine a cumulative relative frequency distribution in terms of the number of particles with respect to L/S. Based on the thus acquired cumulative relative frequency distribution in terms of the number of particles with respect to L/S, by subtracting a cumulative ratio (%) at L/S=1.0 from a cumulative ratio (%) at L/S=4.5, the occupancy (%) in terms of particles of particles of 1.0<L/S≦4.5 can be calculated.

The titanic acid compound comprises preferably 65% or more of particles having an aspect ratio L/S in the range of 1.0<L/S≦4.5 based on the number of particles, and more preferably 70% or more thereof. Further, the titanic acid compound comprises preferably 55% or more of particles having an aspect ratio L/S in the range of 1.5<L/S≦4.0 based on the number of particles, and more preferably 60% or more thereof.

The titanic acid compound according to the present invention may contain sulfur element, and its amount can be made to be 0.1 to 0.5% by mass in terms of the conversion described later. When the titanic acid compound is made to contain sulfur element, since the primary particle of the titanic acid compound easily takes an anisotropic shape (plate-shape, rod-shape, square pole-shape, needle-shape), the Li deintercalation capacity can be enhanced. When the amount of sulfur is smaller than 0.1% by mass, it becomes difficult for the primary particle to take an anisotropic shape; and when exceeding 0.5% by mass, the Li deintercalation capacity becomes liable to conversely decrease.

The content of the sulfur element is determined as a value in terms of SO₃ of % by mass of sulfur in the titanic acid compound as measured by X-ray fluorescence analysis.

Further it is preferable that the titanic acid compound according to the present invention is one having a ratio h₂/h₁ of 0.05 or lower, wherein a maximum value h₁ of dQ/dV between voltages V of 1.5 V and 1.7 V and a maximum value h₂ of dQ/dV between voltages V of 1.8 V and 2.0 V in a curve of voltage V and dQ/dV determined by differentiating, with respect to V, a voltage V-capacity Q curve on the Li deintercalation side of a coin-type battery using the titanic acid compound as an active material of a working electrode and using metallic Li as a counter electrode.

The curve of voltage V and dQ/dV is determined as follows. First, as described in Example 1 described later, a coin-type battery is fabricated using the titanic acid compound as a working electrode, and using metallic lithium as a counter electrode. The coin battery is charged (Li intercalation) to 1 V, and thereafter discharged (Li deintercalation) at 0.1 C to 3 V. At this time, data of the voltage V-capacity Q on the Li deintercalation side are acquired at intervals of 5 mV in the voltage variation amount and/or at intervals of 120 sec. Based on the data thus acquired, a V-Q curve is drawn.

Then, the acquired data of the voltage V and the capacity Q are smoothed, respectively, by a simple moving average method. Specifically, in (2n+1) data (n is optional, but may be 2) arranged in a time series, one (n+1)th data in the middle is replaced by the average value of the (2n+1) data.

Then, there is determined a value obtained by differentiating Qᵢ on an i-th point in these smoothed data with respect to V as follows. That is, there is determined a quadratic function with respect to V passing through three points in total of the point and points just before and after the point, (Vᵢ₋₁, Qᵢ₋₁), (Vᵢ, Qᵢ) and (Vᵢ₊₁, Qᵢ₊₁); and the quadratic function is differentiated with respect to V, and substituted with V=Vᵢ to thereby obtain a differential value. In order to determine a quadratic function passing through three points, the calculation is easy if the interpolation formula of Lagrange is used (reference literature: Hideyo Nagashima, “NUMERICAL METHOD (revised 2nd edition)” (Maki Shoten Publishing Co.)(in Japanese).

The titanic acid compound, when its differential curve on the Li deintercalation side is drawn under the above condition, has at least two peaks between 1.5 to 1.7 V, but peaks are observed also between 1.8 to 2.0 V in some cases. Then, as in the present invention, when the relationship of the maximum values in the each potential range is made as described above, there is made the titanic acid compound high in the Li deintercalation capacity, and excellent in the rate property, particularly in the cycle property. Making the h₂/h₁ to be 0.02 or lower is more preferable. It has been known that the maximum value h₂ between 1.8 V to 2.0 V emerges when a certain or more amount of sub-phases such as titanium oxide and noncrystalline phases is present.

Further the titanic acid compound according to the present invention is preferably high in its crystallinity. Specifically, in an powder X-ray diffraction pattern using a CuKα radiation as a radiation source, it is preferable that the peak intensity ratio I₂/I₁ of a peak intensity I₂ at 2θ=14.0° (error: ±0.5°) to a maximum peak intensity I₁ at 2θ=24.8° (error: ±0.5°) is 1.5 or higher; and 2 to 5 is more preferable. This indicates that crystal planes attributed to 2θ=24.8° develop remarkably; and such a titanic acid compound, though the cause is unclear, becomes high in the Li deintercalation capacity and exhibits the excellent cycle property.

In the present invention, the powder X-ray diffraction measurement is carried out as follows. The diffraction in the angular range of 2θ=5 to 70° is measured by using a CuKα radiation as its line source, and setting the scan speed at 5°/min. For the calculation of the peak intensity ratio, there are used values obtained by subtracting background intensities from the measurement values of the peak intensities. The elimination of the background is carried out by using a fitting method (a simple peak search is carried out and peak portions are removed, and thereafter, a polynominal is obtained by giving a fitting operation to the remaining data).

The titanic acid compound according to the present invention can have shapes of secondary particles made by aggregation of primary particles, and of aggregates made by further aggregation of the primary particles and/or the secondary particles. The secondary particle in the present invention is one in the state that primary particles themselves firmly bind with each other, and is not one made by cohesion by the interparticle mutual action such as van der Waals force, or by mechanical compaction, but one which does not easily crash by usual industrial operations such as mixing, crush, filtration, water washing, transportation, weighing, bagging and piling, and mostly remains as secondary particles. Although the primary particle has an anisotropic shape, the shape of the secondary particle is not especially limited, and the secondary particles having various shapes can be used. The average particle diameter (a median diameter by a laser scattering method) of the secondary particle is preferably in the range of 1 to 50 μm. As described above, the shape of the secondary particle is also not especially limited, and the secondary particles having various shapes can be used, but spherical ones are preferable because the flowability is enhanced. By contrast, the aggregate, unlike the secondary particle, crashes by the above industrial operation. The shape of the aggregate is not especially limited as in the secondary particle, and the aggregates having various shapes can be used.

Then, the present invention is an alkaline metal titanate compound having a specific surface area of 5 to 15 m²/g as measured by BET one-point method using nitrogen adsorption, and having an anisotropic shape, wherein the alkaline metal titanate compound comprises 60% or more of particles having a major-axis diameter L in the range of 0.1<L≦0.9 μm based on the number of particles as measured by electron microscopy. The specific surface area, the particle shape and the major-axis diameter distribution can be determined by the above-mentioned methods.

The alkaline metal titanate compound according to the present invention can be used as an electrode active material, and can further be used as a raw material of titanic acid compounds. Particularly when the alkaline metal titanate compound is used as a raw material of titanic acid compounds, the alkaline metal titanate compound is suitable for production of the titanic acid compound according to the present invention.

The alkaline metal titanate compound preferably has the following composition formula:

MₓTi_{y}O_{z} (2)

wherein M is one or two alkaline metal elements selected from the group consisting of alkaline metal elements; x/y is 0.05 to 2.50, and z/y is 1.50 to 3.50; in the case where M is two elements, x denotes the total of the two elements.

Compounds satisfying the formula (2) more specifically include compounds exhibiting X-ray diffraction patterns of MTiO₂, MTi₂O₄, M₂TiO₃, M₂Ti₃O₇, M₂Ti₄O₉, M₂Ti₅O₁₁, M₂Ti₆O₁₃, M₂Ti₈O₁₇, M₂Ti₁₂O₂₅, M₂Ti₁₈O₃₇, and M₄Ti₅O₁₂ (M in the formula is one or two selected from the group consisting of sodium, potassium, rubidium and cesium).

The compounds more preferably include compounds exhibiting distinctive X-ray diffraction patterns of sodium titanate compounds such as NaTiO₂, NaTi₂O₄, Na₂TiO₃, Na₂Ti₆O₁₃, Na₂Ti₃O₇ and Na₄Ti₅O₁₂, potassium titanate compounds such as K₂TiO₃, K₂Ti₄O₉, K₂Ti₆O₁₃ and K₂Ti₈O₁₇, and cesium titanate compounds such as Cs₂Ti₅O₁₁. Particularly Na₂Ti₃O₇ is preferable.

In the present description, alkaline metal titanate compounds exhibiting X-ray diffraction patterns of MTiO₂ or the like include not only ones having stoichiometric compositions of MTiO₂ or like; but even ones whose some elements are defective or excessive and which have nonstoichiometric compositions are included in that scope as long as the ones exhibit distinctive X-ray diffraction patterns of compounds of MTiO₂ or the like.

For example, a sodium titanate compound exhibiting an X-ray diffraction pattern of Na₂Ti₃O₇ contains, in addition to Na₂Ti₃O₇ of a stoichiometric composition, sodium titanate compounds which do not have a stoichiometric composition of Na₂Ti₃O₇, but exhibit distinctive peaks of Na₂Ti₃O₇ at positions of 2θ of 10.5°, 15.8°, 25.7°, 28.4°, 29.9°, 31.9°, 34.2°, 43.9°, 47.8°, 50.2° and 66.9° (an error of any of which is)±0.5° in an powder X-ray diffraction measurement (using a CuKα radiation).

Further alkaline metal titanate compounds having peaks originated from other crystal structures, that is, alkaline metal titanate compounds having sub-phases in addition to a main phase are included in the scope of the present invention. In the case of having sub-phases, with the intensity of a main peak of the main phase being taken to be 100, the intensities of main peaks attributed to the sub-phases are preferably 30 or lower, and more preferably 10 or lower, and still more preferably, the titanate compound is a single phase containing no sub-phase.

The alkaline metal titanate compound according to the present invention preferably comprises 60% or more of particles having an aspect ratio L/S in the range of 1.0<L/S≦4.5 based on the number of particles as calculated from the major-axis diameter L and the minor-axis diameter S of the each particle by electron microscopy. Such an alkaline metal titanate compound is particularly suitable as a raw material for production of the titanic acid compound according to the present invention. The distribution of the aspect ratio can be determined by the above-mentioned method. The alkaline metal titanate compound comprises preferably 65% or more of particles having an aspect ratio L/S in the range of 1.0<L/S≦4.5 based on the number of particles, and more preferably 70% or more thereof. Further, the alkaline metal titanate compound comprises preferably 55% or more of particles having an aspect ratio L/S in the range of 1.5<L/S≦4.0 based on the number of particles, and more preferably 60% or more thereof.

Then, the present invention is a method for producing an alkaline metal titanate compound comprising a step (step 1) of milling an alkaline metal titanate compound until the specific surface area becomes 10 m²/g or larger, and a step (step 2) of annealing the obtained milled material. By carrying out the method according to the present invention on an alkaline metal titanate compound, there can be obtained the above alkaline metal titanate compound having a specific surface area of 5 to 15 m²/g as measured by BET one-point method using nitrogen adsorption, and having an anisotropic shape, wherein the alkaline metal titanate compound comprises 60% or more of particles having a major-axis diameter L in the range of 0.1<L≦0.9 μm based on the number of particles as measured by electron microscopy.

The alkaline metal titanate compound according to the present invention can be produced simply by the above method.

An alkaline metal titanate compound (hereinafter, referred to as “milling precursor” in some cases) supplied for the milling contains the above-mentioned alkaline metal titanate compound as a main phase, and may contain sub-phases. In the case of having sub-phases, with the intensity of a main peak of the main phase being taken to be 100, the intensities of main peaks attributed to the sub-phases are preferably 50 or lower, and more preferably 30 or lower, and still more preferably, the alkaline metal titanate compound is a single phase containing no sub-phase.

In the present invention, production steps comprise the steps of milling an alkaline metal titanate compound (milling precursor) until its specific surface area becomes 10 m²/g or larger as the step 1, and annealing the obtained milled material as the step 2. For the synthesis of an alkaline metal titanate compound, since it is generally necessary to fire a raw material mixture at a high temperature, the particle growth and sintering of particles themselves are caused and there is obtained an alkaline metal titanate compound providing many of coarse particles and having a small specific surface area. Therefore, a titanic acid compound produced by using the alkaline metal titanate compound as a raw material provides many of coarse particles and comes to have a small specific surface area. Then, by carrying out the present step 1, the number of the coarse particles can be reduced and the specific surface area can be made large. Only by carrying out the step 1, however, when a titanic acid compound to be finally produced is used as an electrode active material, the initial charge and discharge efficiency and the cycle property decrease due to that many of ultrafine particles are contained in the milled material and due to the decrease in the crystallinity of the alkaline metal titanate compound and the formation of sub-phases. Then, by carrying out the present step 2, since whereas the ultrafine particles are absorbed in other particles and disappear and the crystallinity recovers, the particle growth and the sintering of particles themselves are not too much caused, there can be produced an alkaline metal titanate compound having a specific surface area suitable for production of a titanic acid compound, and having a uniform particle size distribution.

The milling is carried out sufficiently if being carried out until the specific surface area of the alkaline metal titanate compound becomes 10 m²/g or larger, and is preferably carried out until the specific surface area becomes 13 m²/g or larger. It suffices if the specific surface area reaches a target one by suitably setting the milling condition and carrying out milling once or a plurality of times. Since the advantage of the present invention can be attained when the milling is carried out to this range, there is not especially any upper limit of the specific surface area, but since the milling requires energy, it suffices if the specific surface area is made to be 30 m²/g or smaller. The specific surface area is measured by the above-mentioned BET one-point method using nitrogen adsorption. A median diameter may be used as an index of the measure of the milling. The median diameter at this time can be made to be, for example, 1.0 μm or smaller, and is preferably made to be 0.6 μm or smaller. It is preferable that the correlation with the above-mentioned specific surface area is determined and a target median diameter is established based thereon.

For the milling, well-known milling machines can be used. The milling may be carried out in a dry state, for example, by using an impact mill such as a hammer mill, a pin mill or a centrifugal mill, a grinding mill such as a fret mill or a roller mill, a compressive crusher such as a flake crusher, a roll crusher or a jaw crusher, or an air flow type mill such as a jet mill; or in a wet state, for example, by using a sand mill, a ball mill, a DYNO-MILL or the like. From the viewpoint of the efficient milling, wet milling, or if dry milling, a grinding mill is preferably used, and wet milling is especially preferable.

A dispersion medium to be used in wet milling is not especially limited, and well-known materials can be used. Examples of the dispersion medium include polar solvents such as water, ethanol and ethylene glycol. Further for the milling, well-known media may be used, and examples thereof include zirconia, titania, zircon and alumina. For the viscosity regulation of a slurry, in the case where the granulation in spray drying is difficult, and for making the control of the particle diameter easy, the milling may be carried out by adding an organic binder. Examples of the organic additive to be used include (1) vinyl-based compounds (polyvinyl alcohol, polyvinyl pyrrolidone, and the like), (2) cellulose-based compounds (hydroxyethyl cellulose, carboxymethyl cellulose, methyl cellulose, ethyl cellulose and the like), (3) protein-based compounds (gelatin, gum arabic, casein, sodium caseinate, ammonium caseinate, and the like), (4) acrylic acid-based compounds (sodium polyacrylate, ammonium polyacrylate and the like), (5) natural polymer compounds (starch, dextrin, agar, sodium alginate, and the like), and (6) synthetic polymer compounds (polyethylene glycol and the like); and at least one selected therefrom can be used. Among these, compounds containing no inorganic component such as sodium are further preferable because being easily decomposed or volatilized by drying, annealing or heating.

In the case where the step 1 is carried out by wet milling, after the wet milling step, it is preferable that drying is carried out without filtration separation of the alkaline metal titanate compound from the dispersion medium; and particularly in the case of using water as the dispersion medium, the present production method is preferable. Alkaline metal titanate compounds including Na₂Ti₃O₇ generally have a high ion exchangeability, and the alkaline metals are easily released. That the present production method is preferable is because: if the alkaline metals are released, the resultant compositions deviate from the compositions of alkaline metal titanate compounds used as the material; and sub-phases are resultantly formed when the annealing of the step 2 is successively carried out, and there decrease the Li deintercalation capacity and the cycle property when titanic acid compounds to be finally produced are used as an electrode active material. Examples of drying methods include reduced-pressure drying, evaporation to dryness, freeze-drying and spray drying; among these, spray drying is industrially preferable.

If spray drying is carried out, a spray dryer to be used can suitably be selected from a disc type, a pressure nozzle type, a two-fluid nozzle type, a three-fluid nozzle type, a four-fluid nozzle type or the like according to the property of a slurry and the processing capability. The control of the diameter of the secondary particle can be carried out, for example, by regulating the solid content concentration in the slurry, or in the case of the disc type, regulating the rotation frequency of the disc, or in the case of the pressure nozzle type, the two-fluid nozzle type, the three-fluid nozzle type, the four-fluid nozzle type or the like, regulating the spray pressure and the nozzle diameter, or otherwise, to thereby control the size of liquid droplets to be sprayed. As the two-fluid nozzle type, for example, a Twin-Jet Nozzle manufactured by Ohkawara Kakoki Co., Ltd. can be used; and as the three-fluid nozzle type and the four-fluid nozzle type, for example, Trispire Nozzle and Micro Mist Spray Dryer manufactured by Fujisaki Electric Co., Ltd. can be used. With respect to the drying temperature, it is preferable that the inlet port temperature is made to be in the range of 150 to 250° C., and the outlet port temperature is made to be in the range of 70 to 120° C. In the case where the viscosity of the slurry is low and the granulation is difficult, or for making the control of the particle diameter easier, an organic binder may be used. Examples of the organic binder to be used include (1) vinyl-based compounds (polyvinyl alcohol, polyvinyl pyrrolidone, and the like), (2) cellulose-based compounds (hydroxyethyl cellulose, carboxymethyl cellulose, methyl cellulose, ethyl cellulose and the like), (3) protein-based compounds (gelatin, gum arabic, casein, sodium caseinate, ammonium caseinate, and the like), (4) acrylic acid-based compounds (sodium polyacrylate, ammonium polyacrylate and the like), (5) natural polymer compounds (starch, dextrin, agar, sodium alginate, and the like), and (6) synthetic polymer compounds (polyethylene glycol and the like); and at least one selected therefrom can be used. Among these, compounds containing no inorganic component such as sodium are further preferable because being easily decomposed or volatilized by drying, annealing or heating.

The annealing (the step 2) of the milled material can be carried out, for example, by putting the milled material in a heating furnace, heating the milled material to a predetermined temperature, holding the temperature for a certain time, and cooling the heated material. As the heating furnace, there can be used a well-known heating apparatus, for example, a fluidized furnace, a stationary furnace, a rotary kiln, or a tunnel kiln. The atmosphere in the annealing may be established optionally according to the purpose, and may be made to be, for example, a non-oxidative atmosphere such as nitrogen gas or argon gas, a reducing atmosphere such as hydrogen gas or carbon monoxide gas, or an oxidative atmosphere such as air or oxygen gas.

It is preferable that the annealing is carried out until the specific surface area of the alkaline metal titanate compound is reduced to 20 to 80% with respect to the specific surface area thereof after the milling. When the reducing ratio is lower than this range, there are insufficient the absorption of ultrafine particles in other particles and the improvement in the crystallinity; and when being higher than this range, the particle growth and the sintering of particles themselves are caused and the effect of the milling is resultantly lessened. A further preferable range thereof is 25 to 70%. It is especially preferable to make the specific surface area of the alkaline metal titanate compound after the annealing to be in the range of 5 to 15 m²/g. The annealing temperature in order to achieve this is suitably in the range of 400 to 800° C. A further preferable range thereof is 450 to 750° C. In order to promote the reaction and suppress the sintering of the product, the annealing may be carried out twice or more repeatedly. The annealing time can suitably be set, but if the annealing temperature is in the above temperature range, about 1 to 10 hours is suitable. The temperature rise rate and the cooling rate can suitably be established. After the annealing, as required, the alkaline metal titanate compound may be subjected to a crush step.

The above milling precursor is obtained by firing a mixture at least containing a titanium oxide and an alkaline metal compound, and is preferably one produced by using the titanium oxide having a content of sulfur element in terms of SO₃ of preferably 0.1 to 1.0% by mass, more preferably 0.2 to 1.0% by mass. When the titanium oxide is made to contain sulfur element in the above range, since the primary particle of a titanic acid compound to be finally obtained comes to easily form an anisotropic shape, the Li deintercalation capacity can be enhanced. By contrast, when the content is lower than 0.2% by mass, particularly lower than 0.1% by mass, the primary particle can hardly form an anisotropic shape; and when exceeding 1.0% by mass, since the sulfur element reacts with Na and other phases such as Na₂SO₄ are produced, and an alkaline metal titanate compound such as Na₂Ti₃O₇ is hardly obtained in a single phase, the Li deintercalation capacity becomes liable to decrease conversely. The content of the sulfur element can be determined by X-ray fluorescence analysis similarly to the above-mentioned measurement of the content of sulfur element in the titanic acid compound. Further if the specific surface area of the alkaline metal titanate compound to be produced here is made to be 10 m²/g or smaller, it is preferable because there is easily developed the effect of the combination of the milling step (step 1) and the annealing step (step 2) to be successively carried out.

The titanium oxide includes titanium oxides such as TiO, Ti₄O₇, Ti₃O₅, Ti₂O₃ and TiO₂, titanium oxide hydrates or hydrous titanium oxides represented by TiO(OH)₂, TiO₂.xH₂O (x is arbitral) and the like. As the titanium oxide hydrate or the hydrous titanium oxide, there can be used metatitanic acid represented by TiO(OH)₂ or TiO₂.H₂O, orthotitanic acid represented by TiO₂.2H₂O, a mixture thereof, or the like. The titanium oxide includes crystalline titanium oxides and noncrystalline titanium oxides, and in the case of the crystalline titanium oxides, there can be used a rutile-type, anatase-type or brookite-type one or a mixed-crystal one thereof, or a mixture thereof.

It is preferable that the titanium oxide has a specific surface area of 80 to 350 m²/g as measured by BET one-point method using nitrogen adsorption. If the titanium oxide having a specific surface area in this range is used, it is preferable because the reactivity of the titanium oxide with the alkaline metal compound in the succeeding firing is enhanced and there can be reduced the intensities of main peaks of sub-phases excepting the alkaline metal titanate compound in the milling precursor.

The alkaline metal compound is not especially limited as long as being a compound containing an alkaline metal (alkaline metal compound). For example, in the case where the alkaline metal is Na, the alkaline metal compound includes salts such as Na₂CO₃ and NaNO₃, hydroxides such as NaOH, and oxides such as Na₂O and Na₂O₂. Further in the case where the alkaline metal is K, the alkaline metal compound includes salts such as K₂CO₃ and KNO₃, hydroxides such as KOH, and oxides such as K₂O and K₂O₂. Among these, from the viewpoint of the cost, the handleability in processes and the suppression of the deliquescence, sodium compounds are preferably used.

The mixing can be carried out by an optional method. Examples thereof include a method of mixing the alkaline metal compound and the titanium oxide in a dry state or in a wet state. The dry mixing of the both can be carried out by stirring and mixing the both, for example, by using a dry milling machine such as a fluid energy mill or an impact mill, a high-speed stirrer such as a Henschel mixer or a high-speed mixer, a mixer such as a sample mixer, or the like. The wet mixing may be carried out, for example, by dispersing both the compounds as a slurry, and passing through a wet milling machine such as a sand mill, a ball mill, a pot mill or a DYNO-MILL. At this time, the slurry may be heated. As the case may be, the slurry after the mixing may be spray dried by such as a spray dryer. If the mixing is carried out by a milling machine or carried out by spray drying, it is preferable because the reactivity of the titanium oxide with the alkaline metal compound in the succeeding firing is enhanced.

The blend ratio of the alkaline metal compound and the titanium oxide may be conformed to the composition of a target alkaline metal titanate compound. For example, in the case where Na₂Ti₃O₇ is produced, the both are blended so that Na/Ti becomes 0.67 to 0.72 in molar ratio. Here, it is preferable that the alkaline metal compound is blended in a blend amount on the slightly larger, for example, 1 to 6% by mol larger, than a blend amount thereof calculated from the stoichiometric ratio of the alkaline metal titanate compound.

Then, a mixture at least containing the titanium oxide and the alkaline metal compound is fired, and allowed to react to thereby obtain a milling precursor. The firing is carried out, for example, by putting the raw materials in a heating furnace, heating to a predetermined temperature, and holding the temperature for a certain time. The heating furnace and the atmosphere to be used can be the same as in the above-mentioned annealing step.

The firing temperature is preferably in the range of 700 to 1,000° C., which makes a milling precursor having a high main phase ratio to be easily obtained. When the firing temperature is lower than the temperature range, the production reaction of the alkaline metal titanate compound hardly proceeds; and when being higher than the temperature range, the firm sintering of products themselves is liable to be caused. A further preferable temperature range is 750 to 900° C. In order to promote the reaction and suppress the sintering of the product, the firing may be carried out twice or more repeatedly. The firing time can suitably be set, and about 1 to 100 hours is suitable. The temperature rise rate and the cooling rate can also suitably be established. The cooling may usually be natural cooling (spontaneous cooling in furnace) or slow cooling. Here, at the temperature at which the alkaline metal titanate compound is produced, since the particle growth is inevitable, coarse particles in the micron order are formed.

Then, the present invention is a method for producing a titanic acid compound, the method comprising a step (step 3) of bringing the alkaline metal titanate compound, obtained by the above-mentioned production method, having a specific surface area of 5 to 15 m²/g as measured by BET one-point method using nitrogen adsorption, and having an anisotropic shape, wherein the alkaline metal titanate compound comprises 60% or more of particles having a major-axis diameter L in the range of 0.1<L≦0.9 μm based on the number of particles as measured by electron microscopy, into contact with an acidic aqueous solution to thereby substituting at least a part of alkaline metal cations in the alkaline metal titanate compound with protons; and the method can obtain a titanic acid compound (hereinafter, referred to also as “proton-substitute”) which is a proton-substitute of the alkaline metal titanate compound. The proton-substitute may be used as an electrode active material, or may be used as a raw material of a titanic acid compound to be obtained through a heating step described later.

Specific examples of the method include a method in which a dispersion liquid containing the alkaline metal titanate compound dispersed in a dispersion medium is prepared, and an acidic aqueous solution is added to the dispersion liquid. As the dispersion medium, for example, water can be used. As the acidic aqueous solution, one in which an acidic compound is dissolved in water can be used.

The acidic compound includes inorganic acids such as hydrochloric acid, sulfuric acid, nitric acid and hydrofluoric acid, and mixtures thereof. When these are used, the reaction easily proceeds and if these are hydrochloric acid or sulfuric acid, it is preferable because the reaction can be carried out industrially advantageously.

The amount and the concentration of the acidic compound are not especially limited, but it is preferable that the amount is an amount equal to or larger than the reaction equivalent weight of the alkaline metal contained in the alkaline metal titanate compound, and the concentration of the free acid is made to be 2 N or lower. The reaction temperature is not especially limited, but it is preferable that the reaction is carried out at a temperature in the range of lower than 100° C., at which the structure of the proton-substitute to be produced hardly changes. The processing time is 1 hour to 7 days, and preferably 2 hours to 1 day. Further in order to shorten the processing time, the solution may suitably be replaced by a fresh one.

In the present step, it is preferable that the content of the alkaline metal in the proton-substitute is reduced as much as possible; and it is preferable that the alkaline metal titanate compound is caused to react with the acidic compound so that the content of the alkaline metal (M) in the proton-substitute obtained in the step of the reaction with the acidic compound becomes 1.0% by mass or lower in terms of oxide of M. The reaction specifically includes (1) making the temperature of the reaction with the acidic compound to be 40° C. or higher, (2) carrying out the reaction with the acidic compound twice or more repeatedly, and (3) reacting with the acidic compound in the presence of trivalent titanium ions, and the reaction may be carried out by combining two or more of these methods. In the method (1), the reaction temperature is preferably made to be lower than 100° C. as described above. The method (3) specifically includes a method in which a soluble trivalent-titanium compound such as titanium trichloride is added to the acidic compound or its solution, and a method in which a soluble tetravalent-titanium compound such as titanyl sulfate or titanium tetrachloride is reduced to thereby cause a trivalent titanium ions to be present. The trivalent-titanium ion concentration in the acidic compound or its solution is preferably in the range of 0.01 to 1% by mass.

The production method according to the present invention can make the alkaline metal content in the proton-substitute to be 1.0% by mass or lower, and further 0.5% by mass or lower, and can further remarkably shorten the time required of the step 3. This is conceivably due to that the alkaline metal titanate compound by the production method according to the present invention is presumed to have high crystallinity and have few coarse particles. Since the alkaline metal content in the proton-substitute can be reduced in such a manner, the control of the composition in a succeeding heating step becomes easy, and an active material excellent in battery property is easily obtained.

The obtained proton-substituted form is, as required, cleaned and solid-liquid separated, and thereafter dried. The cleaning can use water, an acidic aqueous solution or the like. The solid-liquid separation can use a well-known filtration method. The drying can also use a well-known drying method, but since the structure changes depending on the temperature, the drying temperature is suitably established.

Specific examples of the proton-substitute include H₂Ti₃O₇, H₂Ti₄O₉ and H₂Ti₅O₁₁. The specific surface area thereof is preferably made to be 13 to 35 m²/g.

Then, the present invention is the method for producing the titanic acid compound, the method further comprising a step (step 4) of heating the proton-substitute obtained in the above step 3. When the proton-substitute is heated, a part of hydrogen atoms and oxygen atoms among constituent elements of the proton-substitute are eliminated from the crystal lattice to cause the rearrangement of the lattice, and the eliminated oxygen and hydrogen are released as water, to thereby obtain a titanic acid compound. The heating is carried out, for example, by putting the proton-substitute in a heating furnace, heating the proton-substitute to a predetermined temperature, and holding the temperature for a certain time. The heating furnace and the atmosphere to be used can be the same as in the above-mentioned annealing step.

The heating temperature is suitably established according to the kind of the proton-substitute and the kind of a target titanic acid compound. For example, in the case where H₂Ti₁₂O₂₅ as the titanic acid compound is synthesized by using H₂Ti₃O₇ as the proton-substitute, the target titanate compound H₂Ti₁₂O₂₅ can be obtained accompanied by the elimination of H and O. In this case, the heating temperature is in the range of 150° C. to 350° C., and preferably in the range of 250° C. to 350° C. Conventionally, in the case where H₂Ti₁₂O₂₅ as a titanic acid compound is synthesized by using H₂Ti₃O₇ as a proton-substitute, as described in Patent Literature 1, the suitable heating temperature is in the range of 200° C. to 270° C., and the heating was required to be carried out at around 260° C. practically in consideration of the industrial aspect of the processing time, the variation and the like. By using the alkaline metal titanate compound produced by employing the method according to the present invention as the raw material, however, the acceptable range of the heating temperature can be extended and the production condition control is allowed to be relaxed, which leads to an the industrial advantage.

Further in the case where H₂Ti₁₂O₂₅ as the titanic acid compound is synthesized by using H₂Ti₄O₉ as the proton-substitute, the heating is carried out preferably at a temperature in the range of 250 to 650° C., and more preferably in the range of 300 to 400° C. In the case where H₂Ti₁₂O₂₅ as the titanic acid compound is synthesized by using H₂Ti₅O₁₁ as the proton-substitute, the heating is carried out preferably at a temperature in the range of 200 to 600° C., and more preferably in the range of 350 to 450° C.

The heating time is usually 0.5 to 100 hours, and preferably 1 to 30 hours; and the higher the heating temperature, the shorter the heating time can be made.

The titanic acid compound thus obtained makes particles containing few ultrafine particles and having comparatively uniform particle diameters and a special specific surface area. Thereby, when the titanic acid compound is used as an electrode active material, there is obtained the titanic acid compound high in the Li deintercalation capacity, high in the charge and discharge efficiency, capable of being reduced in the decreasing rate of the Li deintercalation capacity involved in the charge and discharge cycle, and excellent in the rate property. Such a titanic acid compound cannot be obtained only simply by milling the titanic acid compound to make fine particles thereof.

The titanic acid compound and the alkaline metal titanate compound according to the present invention are excellent in any of the Li deintercalation capacity, the charge and discharge efficiency, the cycle property, and the rate property. Therefore, an electricity storage device using, as a constituent member, an electrode containing such a compound as an electrode active material is one having a high capacity, being capable of the reversible intercalation and deintercalation reactions of ions of lithium and the like and promising high reliability.

The electricity storage device according to the present invention specifically includes lithium secondary batteries, sodium secondary batteries, magnesium secondary batteries, calcium secondary batteries and capacitors, which are constituted of an electrode containing the titanic acid compound according to the present invention as their electrode active material, a counter electrode, a separator and an electrolyte solution.

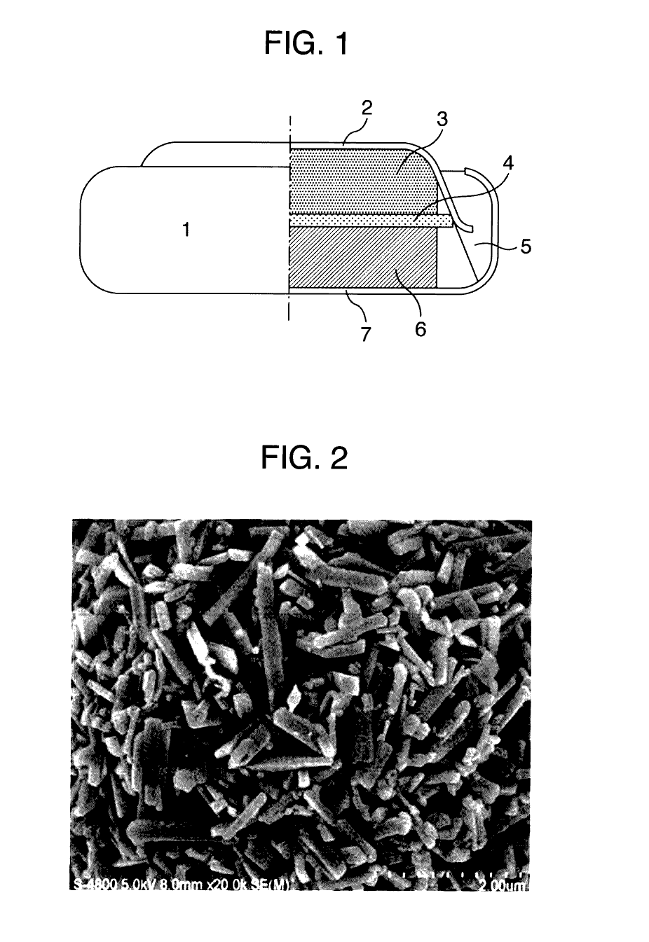

That is, except for using, as the electrode material active material, the titanic acid compound and/or the alkaline metal titanate compound according to the present invention, there can be employed battery elements, as these are, of well-known lithium secondary batteries, sodium secondary batteries, magnesium secondary batteries, calcium secondary batteries and capacitors; and the battery may be any type of a coin type, a button type, a cylinder type, a laminate type, an all solid type and the like. FIG. 1 is a schematic view illustrating one example in which a lithium secondary battery as one example of the electricity storage device according to the present invention is applied to a coin-type lithium secondary battery. The coin-type battery 1 is constituted of a negative electrode terminal 2, a negative electrode 3, (an electrolyte or a separator+an electrolyte solution) 4, an insulating packing 5, a positive electrode 6 and a positive electrode can 7.

An active material containing the titanic acid compound and/or the alkaline metal titanate compound according to the present invention is blended, as required, with a conductive agent, a binder and the like to thereby prepare an electrode mixture, which is pressure bonded on a current collector to thereby fabricate an electrode. As the current collector, there can be preferably used a copper mesh, a stainless steel mesh, an aluminum mesh, a copper foil, an aluminum foil or the like. As the conductive agent, there can be preferably used acetylene black, Ketjen Black or the like. As the binder, there can be preferably used polytetrafluoroethylene, polyvinylidene fluoride or the like.

The blend of the active material containing the titanic acid compound and/or the alkaline metal titanate compound, the conductive agent, the binder and the like in the electrode mixture is not especially limited, but it usually suffices if the blend is made so that the conductive agent is 1 to 30% by mass (preferably 5 to 25% by mass); the binder is 0 to 30% by mass (preferably 3 to 10% by mass); and the rest is the active material containing the titanic acid compound and/or the alkaline metal titanate compound according to the present invention. The active material may contain well-known active materials other than the titanic acid compound and/or the alkaline metal titanate compound, but it is preferable that the titanic acid compound and/or the alkaline metal titanate compound accounts for 50% or more of the electrode capacity; and 80% or more is more preferable.

Among the electricity storage devices according to the present invention, in lithium secondary batteries, as a counter electrode to the above electrode, there can be employed well-known active materials functioning as a positive electrode and being capable of occluding and releasing lithium. As such active materials, various types of oxides and sulfides can be used; and there can be used, for example, manganese dioxide (MnO₂), iron oxide, copper oxide, nickel oxide, lithium manganese complex oxides (for example, LiₓMn₂O₄ or LiₓMnO₂), lithium nickel complex oxides (for example, LiₓNiO₂), lithium cobalt complex oxides (LiₓCoO₂), lithium nickel cobalt complex oxides (for example, LiₓNi_{1-y}Co_{y}O₂), lithium manganese cobalt complex oxides (LiₓMn_{y}Co_{1-y}O₂), lithium nickel manganese cobalt complex oxides (LiₓNi_{y}Mn_{z}Co_{1-y-z}O₂), lithium manganese nickel complex oxides (LiₓMn_{2-y}Ni_{y}O₄) having a spinel structure, lithium phosphorus oxides (LiₓFePO₄, LiₓFe_{1-y}Mn_{y}PO₄, LiₓCoPO₄, LiₓMnPO₄, and the like) and lithium silicon oxides (Li₂ₓFeSiO₄ and the like) having an olivine structure, iron sulfate (Fe₂(SO₄)₃), vanadium oxides (for example, V₂O₅), and solid solution-type composite oxides represented by xLi₂MO₃.(1−x)LiM′O₂ (M and M′ are each the same or dissimilar one or two or more metals). These may be mixed and used. Here, in the above, x, y and z are each preferably in the range of 0 to 1. Further as the positive electrode active material, there may be used organic materials and inorganic materials including conductive polymer materials such as polyaniline and polypyrrole, disulfide-based polymer materials, sulfur (S) and carbon fluoride.

Further among the electricity storage devices according to the present invention, in lithium secondary batteries, as a counter electrode to the above electrode, there can be employed well-known active materials, functioning as a negative electrode and being capable of occluding and releasing lithium, such as metallic lithium, lithium alloys, carbon-based materials such as graphite and MCMB (mesocarbon microbeads).

Among the electricity storage devices according to the present invention, in sodium secondary batteries, as a counter electrode to the above electrode, there can be employed well-known active materials, functioning as a positive electrode and being capable of occluding and releasing sodium, such as sodium transition metal complex oxides such as sodium iron complex oxides, sodium chromium complex oxides, sodium manganese complex oxides and sodium nickel complex oxides.

Further among the electricity storage devices according to the present invention, in sodium secondary batteries, as a counter electrode to the above electrode, there can be employed well-known active materials, functioning as a negative electrode and being capable of occluding and releasing sodium, such as metallic sodium, sodium alloys and carbon-based materials such as graphite.

Among the electricity storage devices according to the present invention, in magnesium secondary batteries and calcium secondary batteries, as a counter electrode to the above electrode, there can be employed well-known active materials, functioning as a positive electrode and being capable of occluding and releasing magnesium and calcium, such as magnesium transition metal complex oxides and calcium transition metal complex oxides.

Further among the electricity storage devices according to the present invention, in magnesium secondary batteries and calcium secondary batteries, as a counter electrode to the above electrode, there can be employed well-known active materials, functioning as a negative electrode and being capable of occluding and releasing magnesium and calcium, such as metallic magnesium, magnesium alloys, metallic calcium, calcium alloys and carbon-based materials such as graphite.

Further among the electricity storage devices according to the present invention, in capacitors, asymmetric capacitors can be made which use a carbon material such as graphite as their counter electrode to the above electrode.

Further in the electricity storage device according to the present invention, a separator, a battery container and the like to be employed may be well-known battery elements.

Further in the electricity storage device according to the present invention, for a nonaqueous electrolyte, there can be used a liquid nonaqueous electrolyte (nonaqueous electrolyte solution) in which an electrolyte is dissolved in a nonaqueous organic solvent, a polymer gelatinous electrolyte in which a polymer material contains a nonaqueous solvent and an electrolyte, a lithium ion-conductive polymer solid electrolyte or inorganic solid electrolyte, or the like.

The nonaqueous organic solvent carries out the function of a medium in which ions participating in the electrochemical reaction of lithium batteries can migrate. As such a nonaqueous organic solvent, there can be used, for example, a carbonate-based, ester-based, ether-based, ketone-based, or another aprotic solvent, or an alcohol-based solvent.

As the carbonate-based solvent, there can be used dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), butylene carbonate (BC), and the like.

As the ester-based solvent, there can be used methyl acetate, ethyl acetate, n-propyl acetate, dimethyl acetate, methyl propionate, ethyl propionate, γ-butyrolactone (GBL), decanolide, valerolactone, mevalonolactone, caprolactone, and the like.

As the ether-based solvent, there can be used dibutyl ether, tetraglyme, diglyme, dimethoxyethane, 2-methyltetrahydrofuran, tetrahydrofuran, and the like.

As the ketone-based solvent, there can be used cyclohexanone and the like.

As the alcohol-based solvent, there can be used ethyl alcohol, isopropyl alcohol, and the like.

As the other aprotic solvents, there can be used nitriles such as R—CN (R is C₂-C₂₀ straight-chain or branched-chain or cyclic-structure hydrocarbon group, and can contain a double bond, an aromatic ring or an ether bond), amides such as dimethylformamide, dioxolanes such as 1,3-dioxolane, sulfolanes, and the like.

The nonaqueous organic solvent may be composed of a single substance, or may be a mixture of two or more solvents. In the case where the nonaqueous organic solvent is a mixture of two or more solvents, the mixing ratio of the two or more solvents is suitably regulated according to the battery performance; and for example, cyclic carbonates such as EC and PC, or a mixed solvent mainly composed of a cyclic carbonate and a nonaqueous solvent having a viscosity lower than that of the cyclic carbonate, or the like can be used.

As the electrolyte, alkali salts can be used; and lithium salts are preferably used. Examples of the lithium salts include lithium hexafluorophosphate (LiPF₆), lithium tetrafluoroborate (LiBF₄), lithium hexafluoroarsenate (LiAsF₆), lithium perchlorate (LiClO₄), lithium bistrifluoromethanesulfonylimide (LiN(CF₃SO₂)₂, LiTSFI), and lithium trifluorometasulfonate (LiCF₃SO₃). These can be used singly or as a mixture of two or more.

The concentration of the electrolyte in the nonaqueous solvent is preferably 0.5 to 2.5 mol/1. When the concentration is 0.5 mol/1 or higher, the resistance of the electrolyte can be reduced and the charge and discharge property can be improved. On the other hand, when being 2.5 mol/1 or lower, the rise in the melting point and the viscosity of the electrolyte can be suppressed and the electrolyte can be made to be liquid at normal temperature.

The liquid nonaqueous electrolyte (nonaqueous electrolyte solution) can further contain additives capable of improving the low-temperature property and the like of lithium batteries. As the additives, there can be used, for example, carbonate-based substances, ethylene sulfite (ES), dinitrile compounds and propane sultone (PS).

The carbonate-based substance can be selected, for example, from the group consisting of vinylene carbonate (VC), vinylene carbonate derivatives having one or more substituents selected from the group consisting of halogens (for example, —F, —Cl, —Br, —I and the like), a cyano group (CN) and a nitro group (—NO₂), and ethylene carbonate derivatives having one or more substituents selected from the group consisting of halogens (for example, —F, —Cl, —Br, —I and the like), a cyano group (—CN) and a nitro group (—NO₂).

The additives may be one substance alone, or may be a mixture of two or more substances. Specifically, the electrolyte solution can further contain one or more additives selected from the group consisting of vinylene carbonate (VC), fluoroethylene carbonate (FEC), ethylene sulfite (ES), succinonitrile (SCN) and propane sultone (PS).

The electrolyte solution preferably contains ethylene carbonate (EC) as a solvent, and a lithium salt as an electrolyte. The electrolyte solution preferably contains, as an additive, at least one selected from vinylene carbonate (VC), ethylene sulfite (ES), succinonitrile (SCN) and propane sultone (PS). These solvent and additive are presumed to have an action to form a film on the titanic acid compound of the negative electrode, and improve the effect of suppressing the gas evolution in the high-temperature environment.

The content of the additives is, with respect to 100 parts by mass of the total amount of the nonaqueous organic solvent and the electrolyte, preferably 10 parts by mass or lower, and more preferably 0.1 to 10 parts by mass. When the content is in this range, the temperature property of batteries can be improved. The content of the additives is still more preferably 1 to 5 parts by mass.

For a polymer material constituting the polymer gelatinous electrolyte, a well-known material can be used. There can be used, for example, polymers of monomers, such as polyacrylonitrile, polyacrylate, polyvinylidene fluoride (PVdF) and polyethylene oxide (PEO), and copolymers with other monomers.

For a polymer material of the polymer solid electrolyte, a well-known material can be used. There can be used, for example, polymers of monomers, such as polyacrylonitrile, polyvinylidene fluoride (PVdF) and polyethylene oxide (PEO), and copolymers with other monomers.

As the inorganic solid electrolyte, a well-known material can be used. For example, ceramic materials containing lithium can be used. There are suitably used a Li₃N glass and a Li₃PO₄—Li₂S—SiS₂ glass.

### EXAMPLES

Hereinafter, Examples will be given and features of the present invention will be made much clearer. The present invention is not limited to these Examples.

Measurement methods of physical properties of each sample will be described.

### (Measurement of the Specific Surface Area)

The specific surface area of a sample was measured by BET one-point method using nitrogen adsorption by using a specific surface area analyzer (Monosorb MS-22, manufactured by Quantachrome Instruments).

### (X-Ray Diffractometry)

The powder X-ray diffraction of a sample was measured by an powder X-ray diffractometer Ultima IV equipped with a high-speed one-dimensional detector D/teX Ultra (both, manufactured by Rigaku Corp.). The measurement was carried out by using Cu-Kα as an X-ray source, at 20 angles of 5 to 70°, and a scanning speed of 5°/min. The identification of a compound was carried out by comparing with PDF cards or well-known literatures. Peak intensities used values obtained by the background elimination (a fitting method: a simple peak search is carried out and peak portions are removed, and thereafter, a polynominal is obtained by giving a fitting operation to the remaining data) from data after the measurement. The peak intensity ratio I₂/I₁ was determined by reading, from an X-ray diffraction chart, a peak intensity I₁ after the background elimination at 2θ=14.0° and a peak intensity I₂ thereafter at 2θ=24.8°.

### (Electron Microscopy)

The major-axis diameter L and the minor-axis diameter S of sample particles were determined by observing the sample particles in a visual field of 10,000× by a scanning electron microscope (SEM)(S-4800, manufactured by Hitachi High-Technologies Corp.), printing the image so that 1 cm corresponded to 0.5 μm, and randomly selecting and measuring 100 particles whose short side was 1 mm or larger. The aspect ratio L/S was determined from the result. The cumulative relative frequency distributions in terms of the number of particles of L and L/S were fabricated from these data. The shape of the sample was also checked by using the scanning electron microscope.

### (Analysis of the Composition)

The concentrations of sulfur and sodium of a sample were measured by using a wavelength dispersive X-ray fluorescence analyzer (RIX-2100, manufactured by Rigaku Corp.). The contents of sulfur and sodium were determined by calculating the masses of SO₃ and Na₂O from amounts of S and Na in the sample, and dividing the masses by a mass of the sample.

### (Median Diameter)

The median diameter was measured by a laser diffraction scattering method. Specifically, the median diameter was measured by using a particle size distribution analyzer (LA-950, manufactured by HORIBA Ltd.). As the dispersion medium, pure water was used; and the refractive index was set at 2.5.

### Example 1

2,000 g of an anatase-type titanium dioxide (specific surface area SSA: 90 m²/g, sulfur element content: 0.3% by mass in terms of SO₃, manufactured by Ishihara Sangyo Kaisha Ltd.) and 820 g of sodium carbonate were mixed at 1,800 rpm for 10 min by using a Henschel mixer (MITSUI HENSCHEL FM20C/I, manufactured by Mitsui Mining Co., Ltd.). 2,400 g out of the mixture was charged in a sagger, and fired in the air at a temperature of 800° C. for 6 hours by using an electric furnace to thereby obtain a milling precursor (Sample A1). The specific surface area of Sample A1 was 8.2 m²/g, and it was confirmed by powder X-ray diffraction measurement that Sample A1 was a single phase of Na₂Ti₃O₇ having a good crystallinity.

### (Step 1)

1,000 g of the obtained Sample A1 was added to 4,000 g of pure water to thereby prepare a slurry having a solid content of 20% by mass. The slurry was milled by using a wet mill machiner (type: MULTI LAB, manufactured by Shinmaru Enterprises Corp.) packed by 80% with zircon beads of 0.5 mm in diameter under the condition of a disc circumferential speed of 10 m/sec and a slurry feed amount of 120 ml/min. The median diameter of the Sample after the milling was 0.31 μm. The slurry was spray dried by using a spray dryer (model: L-8i, manufactured by Ohkawara Kakouki Co., Ltd.) under the condition of an inlet port temperature of 190° C. and an outlet port temperature of 90° C. to thereby obtain Sample A2. The specific surface area of Sample A2 was 21.0 m²/g.

### (Step 2)

The obtained Sample A2 was annealed in an electric furnace in the air at 700° C. for 5 hours to thereby obtain Sample A3. The specific surface area of Sample A3 was 8.2 m²/g, and the reducing rate of the specific surface area due to the annealing was 61%. Further it was confirmed by powder X-ray diffraction that Sample A3 was a single phase of Na₂Ti₃O₇ having a good crystallinity.

The particle shape of Sample A3 was examined by a scanning electron microscope, and was a rod shape. Further as a result of determinations of the major-axis diameter, the minor-axis diameter and the aspect ratio of the particles by the above-mentioned methods, with respect to the major-axis diameter L, the proportion of particles of 0.1<L≦0.9 μm was 85%, and that of 0.1<L≦0.6 μm was 53%. With respect to the aspect ratio, the proportion of particles of 1<L/S≦4.5 was 83%, and that of 1.5<L/S≦4.0 was 68%.

### (Step 3)

1,000 g of this Sample A3 was immersed in an aqueous solution in which 563 g of a 70% sulfuric acid was added to 3,437 g of pure water, allowed to react at 60° C. for 5 hours under stirring, thereafter filtered and washed with water, and dried at 120° C. 830 g out of the dried powder was immersed in an aqueous solution in which 60 g of a 70% sulfuric acid was added to 3,260 g of pure water, allowed to react at 70° C. for 5 hours under stirring, thereafter filtered and washed with water, and dried at 120° C. for 12 hours to thereby obtain a proton-substitute (Sample A4). The specific surface area of Sample A4 was 16.9 m²/g.

The obtained Sample A4 was analyzed for its chemical composition by X-ray fluorescence analysis, which detected 0.087% by mass in terms of Na₂O of sodium, giving a Na removal rate of 99.9% and reasonably giving a chemical formula of a nearly completely proton-exchanged H₂Ti₃O₇. Further by powder X-ray diffraction, it was made clear that Sample A4 was a single phase of H₂Ti₃O₇ having a good crystallinity.

### (Step 4)

780 g of the obtained Sample A4 was dehydrated under heating in an electric furnace in the air at 260° C. for 15 hours to thereby obtain a titanic acid compound (Sample A5). The specific surface area of Sample A5 was 16.1 m²/g.

A scanning electron microscope photograph of Sample A5 is shown in FIG. 2. The particle shape of Sample A5 was a preserved rod shape of the shape of Sample A3 as a starting raw material. Further as a result of determinations of the major-axis diameter, the minor-axis diameter and the aspect ratio of the particles by the above-mentioned methods, with respect to the major-axis diameter L, the proportion of particles of 0.1<L≦0.9 μm was 85%, and that of 0.1<L≦0.6 μm was 53%. With respect to the aspect ratio, the proportion of particles of 1.0<L/S≦4.5 was 83%, and that of 1.5<L/S≦4.0 was 68%. Here, with respect to the number-average values (average values for 100 particles), the major-axis diameter L was 0.68 μm; the minor-axis diameter S was 0.21 μm; and the aspect ratio L/S was 3.24.

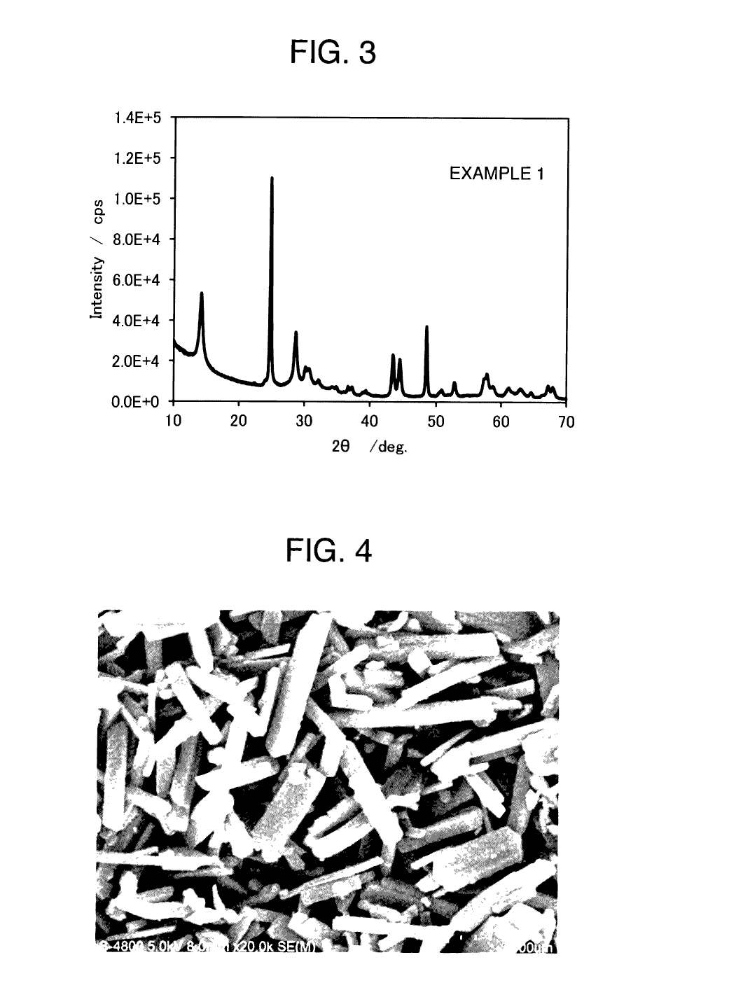

An powder X-ray diffraction diagram using a CuKα radiation of Sample A5 is shown in FIG. 3. The obtained Sample A5 had at least peaks at positions (an error of any of which was ±0.5°) of 2θ=14.0°, 24.8°, 28.7°, 43.5°, 44.5° and 48.6°, and had one peak between 2θ=10 to 20°, which indicated a diffraction pattern characteristic of H₂Ti₁₂O₂₅, as seen in past reports. The peak intensity ratio I₂/I₁ of a peak intensity I₂ at 2θ=24.8° (error: ±0.5°) to a peak intensity I₁ at 2θ=14.0° (error: ±0.5°) was 2.95. Further with the intensity of the peak at 2θ=14.0° (error: ±0.5°) being taken to be 100, no peak having an intensity of 20 or higher excepting the peak at 2θ=14.0° was observed between 10.0°≦2θ≦20.0°.

The chemical composition of Sample A5 was analyzed by X-ray fluorescence analysis, and the content of sulfur element was 0.27% by mass in terms of SO₃. Further the content of sodium was 0.092% by mass in terms of Na₂O.

### Example 2

Sample A1 was used as a milling precursor, and wet milled until the median diameter became 0.24 μm by strengthening the milling condition of the step 1, and spray dried under the same condition as in Example 1 to thereby obtain Sample B2. The specific surface area of Sample B2 was 24.3 m²/g.

Then, Sample B2 was subjected to annealing (step 2) under the same condition as in Example 1 to thereby obtain Sample B3. The specific surface area of Sample B3 was 8.1 m²/g, and the reducing rate of the specific surface area due to the annealing was 67%. The particle shape of Sample B3 was examined by a scanning electron microscope, and was a rod shape. Further with respect to the major-axis diameter, the proportion of particles of 0.1<L≦0.9 μm was 81%, and that of 0.1<L≦0.6 μm was 64%. With respect to the aspect ratio, the proportion of particles of 1.0<L/S≦4.5 was 75%, and that of 1.5<L/S≦4.0 was 66%. It was further confirmed by powder X-ray diffraction that Sample B3 was a single phase of Na₂Ti₃O₇ having a good crystallinity.

Then, Sample B3 was subjected to a proton substitution (step 3) under the same condition as in Example 1 to thereby obtain a proton-substitute (Sample B4). The specific surface area of Sample B4 was 18.0 m²/g. Further by powder X-ray diffraction, it was made clear that Sample B4 was a single phase of H₂Ti₃O₇ having a good crystallinity.

Then, Sample B4 was subjected to heating (step 4) under the same condition as in Example 1 to thereby obtain a titanic acid compound (Sample B5). The specific surface area of Sample B5 was 16.4 m²/g.

As a result of the observation of Sample B5 by a scanning electron microscope, the particle shape of Sample B5 was a preserved rod shape of the shape of Sample B3 as a starting raw material. Further with respect to the major-axis diameter, the proportion of particles of 0.1<L≦0.9 μm was 81%, and that of 0.1<L≦0.6 μm was 64%. With respect to the aspect ratio, the proportion of particles of 1.0<L/S≦4.5 was 75%, and that of 1.5<L/S≦4.0 was 66%. Here, with respect to the number-average values (average values for 100 particles), the major-axis diameter L was 0.62 μm; the minor-axis diameter S was 0.20 μm; and the aspect ratio L/S was 3.46.

As a result of the powder X-ray diffraction of Sample B5, Sample B5 had at least peaks at positions (an error of any of which was ±0.5°) of 2θ=14.0°, 24.8°, 28.7°, 43.5°, 44.5° and 48.6°, and had one peak between 2θ=10 to 20°, which indicated a diffraction pattern characteristic of H₂Ti₁₂O₂₅, as seen in past reports. Further the peak intensity ratio I₂/I₁ of a peak intensity I₂ at 2θ=24.8° (error: ±0.5°) to a peak intensity I₁ at 2θ=14.0° (error: ±0.5°) was 3.48. Further with the intensity of the peak at 2θ=14.0° (error: ±0.5°) being taken to be 100, no peak having an intensity of 20 or higher excepting the peak at 2θ=14.0° was observed between 10.0°≦2θ≦20.0°.

The chemical composition of Sample B5 was analyzed by X-ray fluorescence analysis, and the content of sulfur element was 0.28% by mass in terms of SO₃. Further the content of sodium was 0.059% by mass in terms of Na₂O.

### Example 3

Sample A1 was used as a milling precursor, and wet milled until the median diameter became 0.53 μm by moderating the milling condition of the step 1, and spray dried under the same condition as in Example 1 to thereby obtain Sample C2. The specific surface area of Sample C2 was 16.0 m²/g.

Then, Sample C2 was subjected to annealing (step 2) under the same condition as in Example 1 to thereby obtain Sample C3. The specific surface area of Sample C3 was 7.0 m²/g, and the reducing rate of the specific surface area due to the annealing was 56%. The particle shape of Sample C3 was examined by a scanning electron microscope, and was a rod shape. Further with respect to the major-axis diameter, the proportion of particles of 0.1<L≦0.9 μm was 69%, and that of 0.1<L≦0.6 μm was 36%. With respect to the aspect ratio, the proportion of particles of 1<L/S≦4.5 was 67%, and that of 1.5<L/S≦4.0 was 59%. It was further confirmed by powder X-ray diffraction that Sample C3 was a single phase of Na₂Ti₃O₇ having a good crystallinity.

Then, Sample C3 was subjected to a proton substitution (step 3) under the same condition as in Example 1 to thereby obtain a proton-substitute (Sample C4). The specific surface area of Sample C4 was 14.2 m²/g. Further by powder X-ray diffraction, it was made clear that Sample C4 was a single phase of H₂Ti₃O₇ having a good crystallinity.

Then, Sample C4 was subjected to heating (step 4) under the same condition as in Example 1 to thereby obtain a titanic acid compound (Sample C5). The specific surface area of Sample C5 was 12.9 m²/g.

As a result of the observation of Sample C5 by a scanning electron microscope, the particle shape of Sample C5 was a preserved rod shape of the shape of Sample C3 as a starting raw material. Further with respect to the major-axis diameter, the proportion of particles of 0.1<L≦0.9 μm was 69%, and that of 0.1<L≦0.6 μm was 36%. With respect to the aspect ratio, the proportion of particles of 1.0<L/S≦4.5 was 67%, and that of 1.5<L/S≦4.0 was 59%. Here, with respect to the number-average values (average values for 100 particles), the major-axis diameter L was 0.86 μm; the minor-axis diameter S was 0.22 μm; and the aspect ratio L/S was 4.23.

As a result of the powder X-ray diffraction of Sample C5, Sample C5 had at least peaks at positions (an error of any of which was ±0.5°) of 2θ=14.0°, 24.8°, 28.7°, 43.5°, 44.5° and 48.6°, and had one peak between 2θ=10 to 20°, which indicated a diffraction pattern characteristic of H₂Ti₁₂O₂₅, as seen in past reports. Further the peak intensity ratio I₂/I₁ of a peak intensity I₂ at 2θ=24.8° (error: ±0.5°) to a peak intensity I₁ at 2θ=14.0° (error: ±0.5°) was 2.82. Further with the intensity of the peak at 2θ=14.0° (error: ±0.5°) being taken to be 100, no peak having an intensity of 20 or higher excepting the peak at 2θ=14.0° was observed between 10.0°≦2θ≦20.0°.

The chemical composition of Sample C5 was analyzed by X-ray fluorescence analysis, and the content of sulfur element was 0.20% by mass in terms of SO₃. Further the content of sodium was 0.12% by mass in terms of Na₂O.

### Example 4

A titanic acid compound (Sample D5) was obtained as in Example 1, except for altering the heating temperature of the step 4 to 350° C. As a result of the powder X-ray diffraction of Sample D5, Sample D5 had at least peaks at positions (an error of any of which was ±0.5°) of 2θ=14.0°, 24.8°, 28.7°, 43.5°, 44.5° and 48.6°, and had one peak between 2θ=10 to 20°, which indicated a diffraction pattern characteristic of H₂Ti₁₂O₂₅, as seen in past reports. Further with the intensity of the peak at 2θ=14.0° (error: ±0.5°) being taken to be 100, no peak having an intensity of 20 or higher excepting the peak at 2θ=14.0° was observed between 10.0°≦2θ≦20.0°. From this, it became clear that by using the alkaline metal titanate compound produced by employing the method according to the present invention as the raw material, the acceptable temperature range for heating in the step 4 could be extended.

### Comparative Example 1

A proton-substitute (Sample E4) was obtained by using Sample A1 as a milling precursor, carrying out no step 1 (milling) and no step 2 (annealing), and carrying out the proton substitution (step 3) under the same condition as in Example 1. The specific surface area of Sample E4 was 16.7 m²/g. Then, Sample E4 was subjected to heating (step 4) under the same condition as in Example 1 to thereby obtain a titanic acid compound (Sample E5). The specific surface area of Sample E5 was 14.9 m²/g.

A scanning electron microscope photograph of Sample E5 is shown in FIG. 4. The particles contained mainly rod-shape particles and there were present many coarse particles. Further with respect to the major-axis diameter of the particles, the proportion of particles of 0.1<L≦0.9 μm was 31%, and that of 0.1<L≦0.6 μm was 10%. With respect to the aspect ratio, the proportion of particles of 1.0<L/S≦4.5 was 51%, and that of 1.5<L/S≦4.0 was 43%. Here, with respect to the number-average values, the major-axis diameter L was 1.31 μm; the minor-axis diameter S was 0.30 μm; and the aspect ratio L/S was 4.88.

As a result of the powder X-ray diffraction of Sample E5, Sample E5 had at least peaks nearly at positions of 2θ=14.0°, 24.8°, 28.7°, 43.5°, 44.5° and 48.6°, and had one peak between 2θ=10 to 20°, which indicated a diffraction pattern characteristic of H₂Ti₁₂O₂₅, as seen in past reports. Further the peak intensity ratio I₂/I₁ of a peak intensity I₂ at 2θ=24.8° to a peak intensity I₁ at 2θ=14.0° was 1.49.

The chemical composition of Sample E5 was analyzed by X-ray fluorescence analysis, and the content of sulfur element was 0.24% by mass in terms of SO₃. Further the content of sodium was 0.31% by mass in terms of Na₂O.

### Comparative Example 2

There was used the above Sample A2 obtained by using Sample A1 as a milling precursor and subjecting to the wet milling (step 1) as in Example 1. A proton-substitute (Sample F4) was obtained by carrying out no annealing (step 2), and carrying out the proton substitution (step 3) under the same condition as in Example 1 on the Sample A2. The specific surface area of Sample F4 was 61.9 m²/g. Then, Sample F4 was subjected to heating (step 4) under the same condition as in Example 1 to thereby obtain a titanic acid compound (Sample F5). The specific surface area of Sample F5 was 46.8 m²/g.

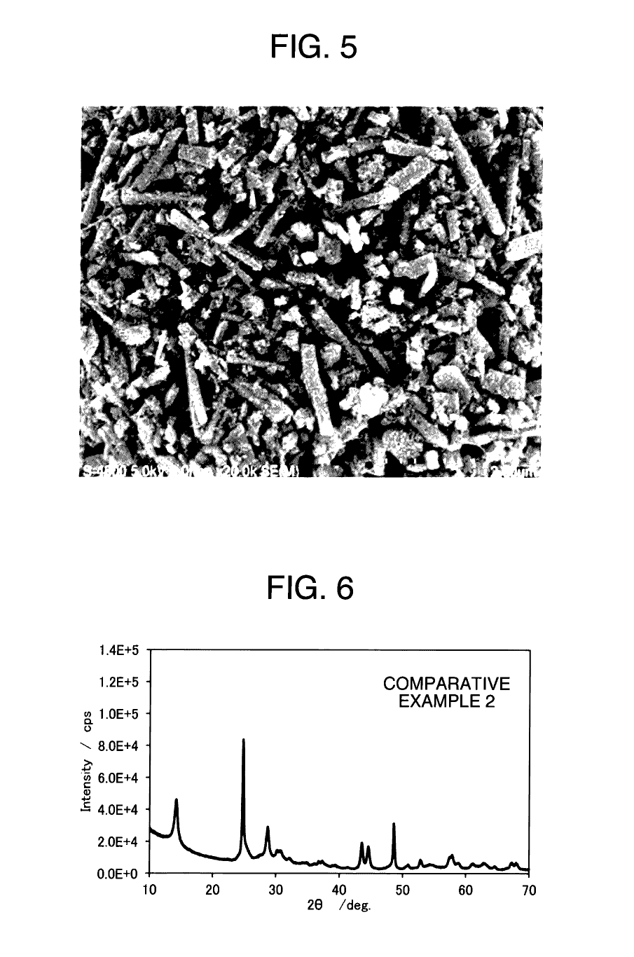

A scanning electron microscope photograph of Sample F5 is shown in FIG. 5. It was found that the particles of Sample F5 were mainly rod-shape particles and comparatively small isotropic angular particles, but there were present ultrafine particles on these particle surfaces.

An powder X-ray diffraction pattern using a CuKα radiation of Sample F5 is shown in FIG. 6. The obtained Sample F5 had at least peaks nearly at positions of 2θ=14.0°, 24.8°, 28.7°, 43.5°, 44.5° and 48.6°, and had one peak between 2θ=10 to 20°, which indicated a diffraction pattern characteristic of H₂Ti₁₂O₂₅, as seen in past reports. Further the peak intensity ratio I₂/I₁ of a peak intensity I₂ nearly at 2θ=24.8° to a peak intensity I₁ at 2θ=14.0° was 2.65.

The chemical composition of Sample F5 was analyzed by X-ray fluorescence analysis, and the content of sulfur element was 0.46% by mass in terms of SO₃. Further the content of sodium was 0.063% by mass in terms of Na₂O.

### Comparative Example 3

There was used the above Sample B2 obtained by using Sample A1 as a milling precursor and subjecting to the wet milling (step 1) as in Example 2. A proton-substitute (Sample G4) was obtained by carrying out no annealing (step 2), and carrying out the proton substitution (step 3) under the same condition as in Example 1, on the Sample B2. The specific surface area of Sample G4 was 81.5 m²/g. Then, Sample G4 was subjected to heating (step 4) under the same condition as in Example 1 to thereby obtain a titanic acid compound (Sample G5). The specific surface area of Sample G5 was 61.4 m²/g.

As a result of the observation of Sample G5 by a scanning electron microscope, it was found that the particles of Sample G5 were mainly rod-shape particles and comparatively small isotropic angular particles, but there were present ultrafine particles on these particle surfaces. It was also observed that the amount of the ultrafine particles present was larger than in Sample F5.

As a result of the powder X-ray diffraction of Sample G5, Sample G5 had at least peaks nearly at positions of 2θ=14.0°, 24.8°, 28.7°, 43.5°, 44.5° and 48.6°, and had one peak between 2θ=10 to 20°, which indicated a diffraction pattern characteristic of H₂Ti₁₂O₂₅, as seen in past reports. Further the peak intensity ratio I₂/I₁ of a peak intensity I₂ nearly at 2θ=24.8° to a peak intensity I₁ at 2θ=14.0° was 3.44.

The chemical composition of Sample G5 was analyzed by X-ray fluorescence analysis, and the content of sulfur element was 0.79% by mass in terms of SO₃. Further the content of sodium was 0.091% by mass in terms of Na₂O.

### Comparative Example 4

2,000 g of a rutile-type titanium dioxide (SSA: 6.2 m²/g, sulfur element content: 0.0% by mass in terms of SO₃, manufactured by Ishihara Sangyo Kaisha Ltd.) and 820 g of sodium carbonate were mixed at 1,800 rpm for 10 min by using a Henschel mixer (MITSUI HENSCHEL FM20C/I, manufactured by Mitsui Mining Co., Ltd.). 2,400 g out of the mixture was charged in a sagger, and fired in the air at a temperature of 800° C. for 6 hours by using an electric furnace to thereby obtain a milling precursor (Sample H1). The specific surface area of Sample H1 was 1.2 m²/g, and it was confirmed by powder X-ray diffraction measurement that Sample H1 was a single phase of Na₂Ti₃O₇ having a good crystallinity.

A titanic acid compound (Sample H5) was obtained as in Comparative Example 1, except for using Sample H1 as a milling precursor. The specific surface area of Sample H5 was 5.6 m²/g.

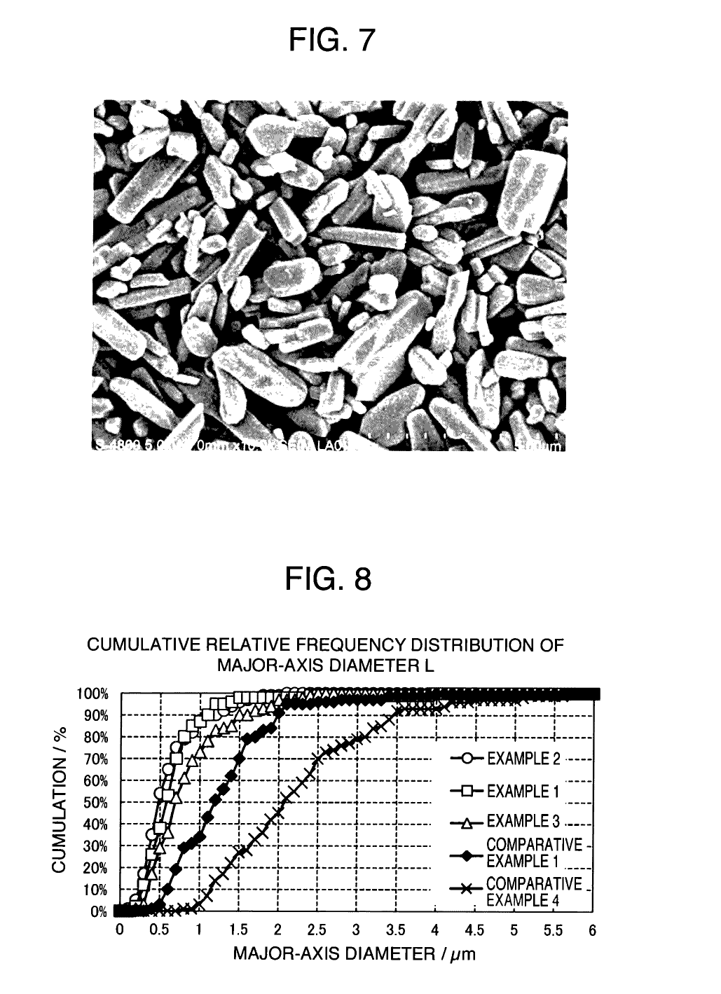

As a result of the observation of Sample H5 by a scanning electron microscope (FIG. 7), many of the particles were platy particles and there were present many coarse particles. Further with respect to the major-axis diameter of the particles, the proportion of particles of 0.1<L≦0.9 μm was 1%, and that of 0.1<L≦0.6 μm was 0%. With respect to the aspect ratio, the proportion of particles of 1.0<L/S≦4.5 was 94%, and that of 1.5<L/S≦4.0 was 73%.

As a result of the powder X-ray diffraction of Sample H5, Sample H5 had at least peaks nearly at positions of 2θ=14.0°, 24.8°, 28.7°, 43.5°, 44.5° and 48.6°, and had one peak between 2θ=10 to 20°, which indicated a diffraction pattern characteristic of H₂Ti₁₂O₂₅, as seen in past reports. Further the peak intensity ratio I₂/I₁ of a peak intensity I₂ nearly at 2θ=24.8° to a peak intensity I₁ at 2θ=14.0° was 1.65.

The chemical composition of Sample H5 was analyzed by X-ray fluorescence analysis, and the content of sulfur element was 0.30% by mass in terms of SO₃. Further the content of sodium was 0.26% by mass in terms of Na₂O.

There are shown in Table 1 the specific surface areas and the proportions (%) of particles of the titanic acid compounds having a major-axis diameter L of 0.1<L≦0.9 μm of the Samples of the Examples and the Comparative Examples.

TABLE 1

| | Specific | Specific | Specific | | | |
|---|---|---|---|---|---|---|
| | Surface Area | Surface Area | Surface | Specific Surface | Specific Surface | |
| | of Milling | After Wet | Area After | Area of proton- | Area of Titanic | Proportion of |
| | Precursor | Milling | Annealing | substitute | Acid Compound | 0.1 < L ≦ 0.9 μm |
| Example 1 | 8.2 | 21.0 | 8.2 | 16.9 | 16.1 | 85 |
| Example 2 | 8.2 | 24.3 | 8.1 | 18.0 | 16.4 | 81 |
| Example 3 | 8.2 | 16.0 | 7.0 | 14.2 | 12.9 | 69 |
| Comparative | 8.2 | — | — | 16.7 | 14.9 | 31 |
| Example 1 | | | | | | |
| Comparative | 8.2 | 21.0 | — | 61.9 | 46.8 | — |
| Example 2 | | | | | | |
| Comparative | 8.2 | 24.3 | — | 81.5 | 61.4 | — |
| Example 3 | | | | | | |
| Comparative | 1.2 | — | — | 7.2 | 5.6 | 1 |
| Example 4 | | | | | | |

Note:
The unit of the specific surface area is m²/g

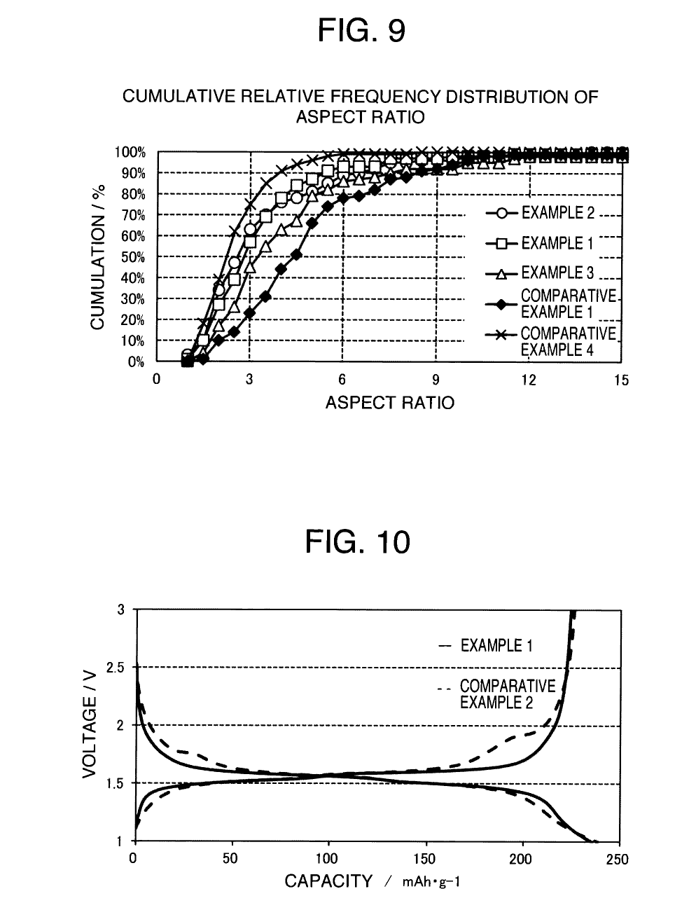

For Examples 1 to 3 and Comparative Examples 1 and 4 (Samples A5, B5, C5, E5 and H5), cumulative relative frequency distributions in terms of the number of particles, with respect to the major-axis diameter L and the aspect ratio L/S, are shown in FIG. 8 and FIG. 9, respectively. It becomes clear that Samples A5, B5 and C5, which had been subjected to milling (step 1) and annealing (step 2), had a smaller major-axis diameter than Samples E5 and H5, which had been subjected to no milling (step 1) and no annealing (step 2), and had a medium aspect ratio.

### Battery Property Evaluation 1: Evaluations of the Li Deintercalation Capacity, the Charge and Discharge Efficiency and the Cycle Property

Lithium secondary batteries were prepared by using Samples A5 to C5 and E5 and H5 as their electrode active material, and evaluated for their charge and discharge property. The form of the batteries and the measurement condition will be described.

The above each Sample, an acetylene black powder as a conductive agent, and a polytetrafluoroethylene resin as a binder were mixed in a mass ratio of 5:4:1, kneaded together in a mortar, stretched into a sheet form, and formed into a circle of 10 mm in diameter to make a pellet form. The thickness was regulated so that the mass of the pellet became about 10 mg. This pellet was interposed between two aluminum meshes cut out in 10 mm in diameter, and pressed at 9 MPa to thereby make a working electrode.

The working electrode was vacuum dried at a temperature of 220° C. for 4 hours, and assembled as the working electrode in a hermetically sealable coin-type evaluation cell, in a glove box in an argon gas atmosphere at a temperature of the dew point—60° C. or lower. As the evaluation cell, there was used one whose material was a stainless steel (SUS316) and which had an outer diameter of 20 mm and a height of 3.2 mm. As its counter electrode, there was used metallic lithium of 0.5 mm in thickness formed into a circle of 12 mm in diameter. As its nonaqueous electrolyte solution, there was used a mixed solution of ethylene carbonate and dimethyl carbonate (1:2 in volume ratio) in which LiPF₆ was dissolved in a concentration of 1 mol/1.

The working electrode was put on a lower can of the evaluation cell; a porous polypropylene film as a separator was put thereon; and the nonaqueous electrolyte solution was dropped thereon. Further thereon, the counter electrode, a spacer of 1 mm in thickness for regulating the thickness and a spring (either was of SUS316) were put; and an upper can with a polypropylene gasket was covered thereon and the outer peripheral edge portion was caulked and hermetically sealed.

The measurement of the charge and discharge capacity was carried out by setting the voltage range to be 1.0 to 3.0 V and the charge and discharge current to be 0.11 mA and carrying out 11 cycles of the charge and discharge at the constant current at room temperature. FIG. 10 shows first-cycle charge and discharge curves of Example 1 and Comparative Example 2 as typical examples.

The Li deintercalation capacity of the first cycle at this time was taken as an initial capacity.

Further the ratio thereof to the Li intercalation capacity of the first cycle, (a first-cycle Li deintercalation capacity/a first-cycle Li intercalation capacity)×100, was taken as a charge and discharge efficiency. It can be said that the higher this value, the higher the charge and discharge efficiency.

From the 12th cycle, by setting the charge and discharge current at 0.22 mA, 59 cycles of the charge and discharge was carried out at room temperature at the constant current, and the cycle property was evaluated. 70 cycles in total was thus carried out, and from the Li deintercalation capacity of the 70th cycle, (a 70th-cycle Li deintercalation capacity/a first-cycle Li deintercalation capacity)×100 was taken as the cycle property. The higher this value, the better the cycle property.

### Battery Property Evaluation 2: V-dQ/dV

The above-mentioned differential curve V-dQ/dV was determined as follows. The evaluation cell was charged (Li intercalation) to 1 V, and thereafter discharged (Li deintercalation) to 3 V at 0.1 C. At this time, data of the voltage V-capacity Q on the Li deintercalation side were acquired at intervals of 5 mV in the voltage variation amount and/or at intervals of 120 sec. Based on the data thus acquired, a V-Q curve was drawn. By using a Li deintercalation curve of the second cycle, and before differential values were calculated, the acquired data of the voltage V and the capacity Q were smoothed, respectively, by a simple moving average method. Specifically, in 5 data arranged in a time series, one third data in the middle was replaced by the average value of the 5 data. This process was carried out on all the data and a smoothened V-Q curve was drawn.

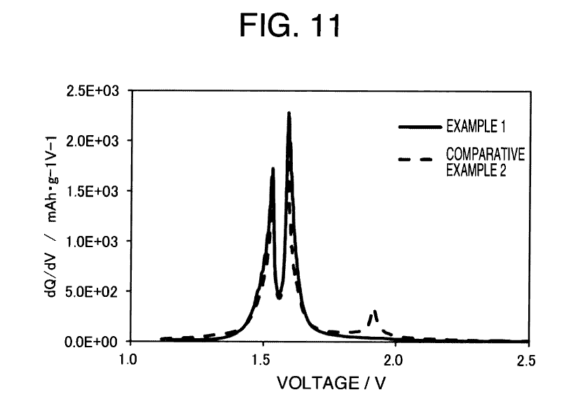

Then, differential values were calculated. There was determined a value obtained by differentiating Qi on an i-th point in these smoothed data with respect to V as follows. That is, there was determined a quadratic function with respect to V passing through three points which are the point and points just before and after the point, (Vᵢ₋₁, Qᵢ₋₁), (Vᵢ, Qᵢ) and (Vᵢ₊₁, Q_{i±1}); and the quadratic function was differentiated with respect to V, and substituted with V=Vᵢ to thereby obtain a differential value. In order to determine a quadratic function passing through three points, the interpolation formula of Lagrange was used. FIG. 11 shows V-dQ/dV curves of Example 1 and Comparative Example 2 as typical examples.

Then, there were read a maximum value h₁ of dQ/dV between voltages V of 1.5 and 1.7 V and a maximum value h₂ of dQ/dV between voltages V of 1.8 and 2 V, and the ratio h₂/h₁ was calculated.

### Battery Property Evaluation 3: The Rate Property (Li Intercalation Side)

Lithium secondary batteries were prepared by using Samples A5 to C5 and E5 to H5 as their electrode active material, and the charge and discharge property thereof were evaluated. The forms of the batteries and the measurement condition will be described.

The above each Sample, an acetylene black powder as a conductive agent, and an N-methyl-2-pyrrolidone (NMP) solution of a polyvinylidene fluoride (PVdF) resin as a binder were mixed so as to become 83:10:7 in mass ratio in terms of solid content; and NMP was further added so that the solid content became 35% by weight. The mixture was kneaded by a planetary mixer (Awatorirentaro ARE-310, manufactured by Thinky Corp.) to thereby fabricate a paste. The fabricated paste was applied on an aluminum foil, dried at 80° C. for 20 min, punched out into a circle of 12 mm, and pressed at 10 MPa to thereby make an electrode. The application amount (application thickness) was regulated so that the active material amount on the electrode punched out into 12 mm became 9 mg.

This working electrode was vacuum dried at a temperature of 120° C. for 4 hours, and thereafter assembled as a positive electrode in a hermetically sealable coin-type evaluation cell, in a glove box in an argon gas atmosphere at a temperature of the dew point—60° C. or lower. As the evaluation cell, there was used one whose material was a stainless steel (SUS316) and which had an outer diameter of 20 mm and a height of 3.2 mm. As its negative electrode, there was used metallic lithium of 0.5 mm in thickness formed into a circle of 14 mm in diameter. As its nonaqueous electrolyte solution, there was used a mixed solution of ethylene carbonate and dimethyl carbonate (1:2 in volume ratio) in which LiPF₆ was dissolved in a concentration of 1 mol/1.

The working electrode was put on a lower can of the evaluation cell; a porous polypropylene film as a separator was put thereon; and the nonaqueous electrolyte solution was dropped thereon. Further thereon, the negative electrode, a spacer of 1 mm in thickness for regulating the thickness and a spring (either was of SUS316) were put; and an upper can with a polypropylene gasket was covered thereon and the outer peripheral edge portion was caulked and hermetically sealed.

The measurement of the charge and discharge capacity was carried out by setting the voltage range to be 1.0 to 3.0 V, fixing the discharge (Li deintercalation) current at 0.33 mA, setting the charge (Li intercalation) current at 0.33 or 8.25 mA, and at room temperature at the constant currents. Here, from the capacity when the current value was 0.33 mA and the capacity when the current value was 8.25 mA, (a Li intercalation capacity at 8.25 mA/a Li intercalation capacity at 0.33 mA)×100 was taken as a rate property. The higher this value, the better the rate property.

The results of the above battery property evaluations are shown collectively in Table 2. It is clear that although Comparative Examples 2 and 3, whose specific surface areas were larger than 30 m²/g, were high in the initial capacity, the charge and discharge efficiencies were low and the cycle property was also low. Further h₂/h₁ was also higher than 0.05. From this, production of sub-phases was hinted. Comparative Example 1, in which the proportion of particles having a major-axis diameter of 0.1<L≦0.9 μm was lower than 60%, also had a low initial capacity. Further it is clear that any Examples had the higher rate property than any Comparative Examples. From the above, it becomes clear that when the titanic acid compound according to the present invention is used as an electrode active material of an electricity storage device, there can be obtained the electricity storage device higher in the capacity, higher in the charge and discharge efficiency, more reduced in the decreasing rate of the Li deintercalation capacity involved in the charge and discharge cycle, and better in the rate property than conventional ones.

TABLE 2

| | | | Charge and | | |
|---|---|---|---|---|---|
| | | Initial | Discharge | Cycle | Rate |
| | | Capacity | Efficiency | Property | Property |
| | h₂/h₁ | (mAh/g) | (%) | (%) | (%) |
| Example 1 | 0.00 | 222 | 86 | 98 | 58.9 |
| Example 2 | 0.00 | 223 | 87 | 97 | 58.8 |
| Example 3 | 0.00 | 218 | 87 | 98 | 53.9 |
| Comparative | 0.00 | 214 | 87 | 98 | 0.1 |
| Example 1 | | | | | |
| Comparative | 0.18 | 228 | 84 | 93 | 44.9 |
| Example 2 | | | | | |
| Comparative | 0.40 | 228 | 84 | 91 | 0.1 |
| Example 3 | | | | | |
| Comparative | 0.00 | 203 | 81 | 96 | 0.2 |
| Example 4 | | | | | |

### INDUSTRIAL APPLICABILITY

According to the present invention, a titanic acid compound and/or an alkaline metal titanate compound is enabled to be provided which, when being used as an electrode active material of an electricity storage device, can provide the electricity storage device whose capacity can be more enhanced and which is excellent in the charge and discharge cycle property and the rate property.

### REFERENCE SIGNS LIST

1: COIN-TYPE BATTERY
2: NEGATIVE ELECTRODE TERMINAL
3: NEGATIVE ELECTRODE
4: ELECTROLYTE, or SEPARATOR+ELECTROLYTE SOLUTION
5: INSULATING PACKING
6: POSITIVE ELECTRODE
7: POSITIVE ELECTRODE CAN

1. A titanic acid compound, having a specific surface area of 10 to 30 m²/g as measured by BET one-point method using nitrogen adsorption, and having an anisotropic shape,
wherein the titanic acid compound comprises 60% or more of particles having a major-axis diameter L in the range of 0.1<L≦0.9 μm based on the number of particles as measured by electron microscopy.

2. The titanic acid compound according to claim 1, wherein the titanic acid compound comprises 60% or more of particles having an aspect ratio L/S in the range of 1.0<L/S≦4.5 based on the number of particles as calculated from the major-axis diameter L and a minor-axis diameter S of the each particle by electron microscopy.

3. The titanic acid compound according to claim 1, having peaks at least at positions of 2θ=14.0°, 24.8°, 28.7°, 43.5°, 44.5° and 48.6° (with an error of ±0.5° for each case) in an powder X-ray diffraction pattern using a CuKα radiation as a radiation source, wherein with an intensity of the peak at 2θ=14.0° (with an error of ±0.5°) being taken to be 100, no peak having an intensity of 20 or higher is observed between 10.0°≦2θ≦20.0° except for the peak at 2θ=14.0°.

4. The titanic acid compound according to claim 1, having a ratio h₂/h₁ of 0.05 or lower,
wherein
h₁ is a maximum value of dQ/dV at a voltage V in between 1.5 V and 1.7 V, and
h₂ is a maximum value of dQ/dV at a voltage V in between 1.8 V and 2.0 V, in a voltage V-dQ/dV curve,
wherein the voltage V-dQ/dV curve is determined by differentiating capacity Q of the voltage V-capacity Q curve, with respect to V, obtained at the Li deintercalation side of a coin-type battery,
wherein the battery uses the titanic acid compound as a working electrode and a metallic Li as a counter electrode.

5. The titanic acid compound according to claim 1, wherein the titanic acid compound has a content of sulfur element of 0.1 to 0.5% by mass in terms of SO₃.

6. The titanic acid compound according to claim 1, wherein the particle comprises a compound represented by the general formula H₂Ti₁₂O₂₅ as a main component.

7. An alkaline metal titanate compound, having a specific surface area of 5 to 15 m²/g as measured by BET one-point method using nitrogen adsorption, and having an anisotropic shape,
wherein the alkaline metal titanate compound comprises 60% or more of particles having a major-axis diameter L in the range of 0.1<L≦0.9 μm based on the number of particles as measured by electron microscopy.

8. The alkaline metal titanate compound according to claim 7, wherein the alkaline metal titanate compound comprises 60% or more of particles having an aspect ratio L/S in the range of 1.0<L/S≦4.5 based on the number of particles as calculated from the major-axis diameter L and a minor-axis diameter S of the each particle by electron microscopy.

9. The alkaline metal titanate compound according to claim 7, wherein the particle comprises a compound represented by the general formula Na₂Ti₃O₇ as a main component.

10. A method for producing an alkaline metal titanate compound according to claim 7, comprising a step of milling an alkaline metal titanate compound until the specific surface area thereof becomes 10 m²/g or larger, and a step of annealing the obtained milled material.

11. The method for producing an alkaline metal titanate compound according to claim 10, wherein the milling is carried out in wet milling.

12. The method for producing an alkaline metal titanate compound according to claim 11, further comprising, after the wet milling step, a step of drying the alkaline metal titanate compound and a dispersion medium without filtration separation.

13. The method for producing an alkaline metal titanate compound according to claim 12, wherein the drying is carried out by a spray dryer.

14. The method for producing an alkaline metal titanate compound according to claim 10, wherein the annealing is carried out until the specific surface area of the alkaline metal titanate compound after the annealing is reduced to 20 to 80% of the specific surface area thereof before the annealing.

15. The method for producing an alkaline metal titanate compound according to claim 10, comprising a step of firing a mixture containing, at least, a titanium oxide having a content of sulfur element of 0.1 to 1.0% by mass in terms of SO₃, and an alkaline metal compound to thereby produce the alkaline metal titanate compound having a specific surface area of 10 m²/g or smaller.

16. The method for producing an alkaline metal titanate compound according to claim 15, wherein the titanium oxide has a specific surface area of 80 to 350 m²/g as measured by BET one-point method using nitrogen adsorption.

17. A method for producing a titanic acid compound, comprising a step of bringing the alkaline metal titanate compound obtained by a production method according to claim 10, into contact with an acidic aqueous solution to thereby substituting at least a part of alkaline metal cations in the alkaline metal titanate compound with protons.

18. A method for producing a titanic acid compound, further comprising a step of heating a proton-substituted titanic acid compound obtained by a production method according to claim 17.

19. The method for producing a titanic acid compound according to claim 18, wherein a heating temperature in the heating step is 150 to 350° C.

20. The method for producing a titanic acid compound according to claim 10, wherein the alkaline metal is sodium.

21. An electrode active material, comprising the titanic acid compound and/or the alkaline metal titanate compound according to claim 1.

22. An electricity storage device, comprising the electrode active material according to claim 21.

23. An electrode active material, comprising the titanic acid compound and/or the alkaline metal titanate compound according to claim 7.

24. An electricity storage device, comprising the electrode active material according to claim 23.
